(19) United States
(12) Patent Application Publication
(10) Pub. No.: US 2023/0198024 A1
(43) Pub. Date: Jun. 22, 2023

(54) METHOD FOR MANUFACTURING A LITHIUM-ION BATTERY

(71) Applicant: I-TEN, Dardilly (FR)

(72) Inventor: Fabien GABEN, Dardilly (FR)

(21) Appl. No.: 17/999,164

(22) PCT Filed: May 19, 2021
(86) PCT No.: PCT/IB2021/054292

§ 371 Date: Nov. 17, 2022

(30) Foreign Application Priority Data
May 20, 2020 (FR) 2005140

(51) Int. Cl. H01M 10/0585; H01M 10/0525; H01M 50/121; H01M 50/124

(52) U.S. Cl. CPC H01M 10/0585; H01M 10/0525; H01M 50/121; H01M 50/124

(57) ABSTRACT

A battery, and a method for manufacturing at least one battery. The method includes forming a stack formed by an alternating succession of cathode strata and anode strata, each cathode stratum forming cathode entities and each anode stratum forming anode entities. The method further includes conducting a heat treatment and/or a mechanical compression of the formed stack to form a consolidated stack, and then making a pair of main cuts between two adjacent empty zones, in a top view, so as to expose an anode connection zone and an cathode connection zone, and to separate a given battery, formed from a given row (Rₙ), from at least one other adjacent battery, formed from at least one adjacent row (Rₙ₊₁).

### CROSS-REFERENCE TO RELATED APPLICATION

The present application is a National Stage Application of PCT International Application No. PCT/IB2021/054292 (filed on May 19, 2021), under 35 U.S.C. § 371, which claims priority to French Patent Application No. FR 2005140 (filed on May 20, 2020), which are each hereby incorporated by reference in their complete respective entireties.

### TECHNICAL FIELD

The present invention relates to the field of batteries, and more particularly to lithium-ion batteries. The invention concerns a new method of manufacturing batteries, and in particular lithium-ion batteries which have a new architecture which gives them an improved service life.

### BACKGROUND

All-solid-state rechargeable lithium-ion batteries are known. WO 2016/001584 (I-TEN) describes a lithium-ion battery manufactured from anode foils comprising a conductive substrate successively covered with an anode layer and an electrolyte layer, and cathode foils comprising a conductive substrate successively covered with a cathode layer and an electrolyte layer; these foils are cut, before or after deposition, according to U-shaped patterns. These foils are then alternately stacked in order to constitute a stack of several unit cells. The patterns of cutting the anode and cathode foils are placed in a “head-to-tail” configuration so that the stack of the cathodes and anodes is laterally offset. Then an encapsulation system with a thickness of about ten microns is deposited on the stack and in the available cavities present within the stack. This encapsulation system ensures the rigidity of the structure at the cutting planes and protects the battery cell from the atmosphere. Once the stack has been made and encapsulated, it is cut along cutting planes to obtain unit batteries, with the exposure, on each of the cutting planes, of the cathode connection zones and the anode connection zones of the batteries. It is found that during these cuts, the encapsulation system can be torn off, resulting in a discontinuity in the sealing of the battery. It is also known to add terminations (i.e. electrical contacts) where these cathode and anode connection zones are apparent.

It appeared that this known solution may however have some drawbacks. Indeed, depending on the positioning of the electrodes, in particular the proximity of the edges of the electrodes for multilayer batteries and the cleanliness of the cuts, a leakage current may appear on the ends, typically in the form of a creeping short-circuit. This creeping short-circuit decreases the battery performance despite the use of an encapsulation system around the battery and around the cathode and anode connection zones. Moreover, there is sometimes an unsatisfactory deposition of the encapsulation system on the battery, in particular on the edges of the battery at spaces created by the lateral offsets of the electrodes on the edges of the battery.

The present invention aims at overcoming at least in part some drawbacks of the prior art which are mentioned above, in particular at obtaining rechargeable lithium-ion batteries with high energy density and high power density.

It aims in particular at increasing the production efficiency of rechargeable lithium-ion batteries with high energy density and high power density, and at making more efficient encapsulations at lower cost.

It aims in particular at proposing a method which reduces the risk of a creeping or accidental short-circuit and which allows manufacturing a battery having a low self-discharge.

It aims in particular at proposing a method which allows simply, reliably and quickly manufacturing a battery having a very long life service.

It also aims at proposing a method for manufacturing simple, fast and cost-effective batteries.

### SUMMARY

A first object of the invention is a battery for manufacturing at least one battery (1000), each battery comprising at least one anode entity (110) and at least one cathode entity (140), disposed one above the other in an alternating manner in a frontal direction (ZZ) of the battery (1000), in which battery, the anode entity (110) comprises: an anode current collector substrate (10), at least one anode layer (20), and possibly a layer of an electrolyte material (30) or a separator (31) impregnated with an electrolyte, and in which battery the cathode entity (140) comprises a cathode current collector substrate (40), at least one cathode layer (50), and possibly a layer of an electrolyte material (30) or a separator (31) impregnated with an electrolyte.

The battery (1000) has six faces, namely, two faces called front faces (F1, F2) which are mutually opposite, in particular mutually parallel, generally parallel to each anode entity (110) and, to each cathode entity (140), two faces called lateral faces (F3, F5) which are mutually opposite, in particular mutually parallel; and two faces called longitudinal faces (F4, F6), which are mutually opposite, in particular mutually parallel. Given that the first longitudinal face (F6) of the battery comprises at least one anode connection zone (1002) and that a second longitudinal face (F4) of the battery comprises at least one cathode connection zone (1006), the anode (1002) and cathode (1006) connection zones being laterally opposite, each anode entity (110) and each cathode entity (140) comprising a respective primary body (111, 141), separated from a respective secondary body (112, 142) by a free space (113, 143) of any material of electrode, electrolyte and current collector substrate.

When the battery comprises several free spaces (113), in the frontal direction (ZZ) of the battery: the free spaces formed between each primary body (111) and each secondary body (112) of each anode entity (110) are superimposed; the free spaces formed between each primary body (141) and each secondary body (142) of each cathode entity (140) are superimposed; and the free spaces of each anode entity (110) and each cathode entity (140) are not coincident.

The manufacturing method comprises: a) making a stack (I) comprising, in top view, x rows with x strictly greater than 1 as well as y line(s) with y greater than or equal to 1, so as to form a number (x*y) of batteries, this stack being formed by an alternating succession of strata (SA, SC) respectively cathode (SC) and anode (SA) strata, each cathode stratum (SC) being intended to form a number (x*y) of cathode entities (140) while each anode stratum (SA) is intended to form a number (x*y) of anode entities (110), each stratum (SA, SC) comprising a plurality of primary preforms (111′, 141′), respectively anode (111′) and cathode (141′) primary preforms, each of which is intended to form a respective primary body (111, 141), a plurality of secondary preforms (112′, 142′), respectively anode (112′) and cathode (142′) secondary preforms, each of which is intended to form a respective secondary body (112, 142), the primary preform (111′, 141′) and the secondary preform (112′, 142′) being mutually separated by a zone called empty zone (80″, 70″), which is intended to form at least one of the free spaces (113, 143), and when the battery comprises several free spaces (113), in the frontal direction (ZZ) of the battery; the empty zones (80″) of the different anode strata (SA) are superimposed; the empty zones (70″) of the different cathode strata (SC) are superimposed; and the empty zones (80″, 70″) of each anode stratum (SA) and each cathode stratum (SC) are not coincident.

The manufacturing method further comprises: b) carrying out a heat treatment and/or a mechanical compression of the stack (I) obtained in step a) so as to form a consolidated stack; and c) making a pair of main cuts (DYn, DY′n) between two adjacent empty zones (80″, 70″), in top view, so as to expose the anode connection zone (1002) and the cathode connection zone (1006), and to separate a given battery, formed from a given row (Rₙ), from at least one other adjacent battery, formed from at least one adjacent row (Rₙ₊₁).

According to a first embodiment, each stratum (SA, SC) is formed by a foil in one piece, the empty zones corresponding in particular to material falls in the foil (70, 80, 70′, 80′).

According to another embodiment, each stratum (SA, SC) is formed by a plurality of independent strips (A₁, A₂, Aₙ, C₁, C₂, Cₙ), the empty zones (113′, 143′) being defined between the edges (LA, LC) facing the adjacent strips.

According to a first variant of the invention, empty zones called small empty zones (80, 70) referred to as slots are made, each empty zone, called small empty zone, is intended to form a single free space.

According to a second variant of the invention, empty zones called large empty zones (80′, 70′) referred to as notches are made, each large empty zone being intended to form a plurality of free spaces in the same row, in particular all free spaces of the same row (Rₙ).

According to an advantageous feature of the invention, the empty zones (70, 70′, 80, 80′) have a rectangular shape, in particular an I-shape.

According to one feature of the invention, one makes after step b), during a step d), a pair of accessory cuts (DXn, DX′n) allowing separating a given line (Lₙ) from at least one adjacent line (Lₙ₋₁, Lₙ₊₁) belonging to the consolidated stack.

According to another feature of the invention, one carries out, during a step e), the impregnation of the consolidated stack obtained in step b) or the impregnation of the line (Lₙ) of batteries (1000) obtained in step d) when step d) is carried out, by a lithium ion carrier phase such as liquid electrolytes or an ionic liquid containing lithium salts, such that the separator layer (31) is impregnated with an electrolyte.

According to one feature of the invention, one carries out, before step c) and after step e) if the latter is carried out or else, if step e) is not carried out, after step d) if step d) is carried out or else, if steps e) and d) are not carried out, after step b), a step f) of encapsulation of the consolidated stack or the line (Ln) of batteries (1000), preferably, in which one covers, by an encapsulation system (95), the outer periphery of the stack (I) or the line (Lₙ) of batteries (1000), preferably the front faces of the stack (F1, F2) or the line (Ln) of batteries (FF1, FF2), the lateral faces (F3, F5, FF3, FF5) and the longitudinal faces (F4, F6, FF4, FF6) of the stack (I) or the line (Ln) of batteries (1000).

The encapsulation system (95) preferably comprises: optionally, at least one first cover layer, preferably selected from parylene, parylene type F, polyimide, epoxy resins, silicone, polyamide, sol-gel silica, organic silica and/or a mixture thereof, deposited on the outer periphery of the stack (I) or the line (Ln) of batteries (1000); optionally a second cover layer composed of an electrically insulating material deposited by deposition of atomic layers, on the outer periphery of the stack (I) or on the outer periphery of the line (Ln) of batteries (1000) or on the first cover layer; and at least one third waterproof cover layer, preferably having a water vapor permeance (WVTR) of less than 10⁻⁵ g/m²·d, this third cover layer being composed of a ceramic material and/or a low melting point glass, preferably a glass whose melting point is less than 600° C., deposited on the outer periphery of the stack (I) or on the outer periphery of the line (Lₙ) of batteries (1000), or the first cover layer. Given that a sequence of at least one second cover layer and at least one third cover layer can be repeated z times withz≥1 and deposited on the outer periphery of at least the third cover layer, and that the last layer of the encapsulation system is a waterproof cover layer, preferably having a water vapor permeance (WVTR) of less than 10⁻⁵ g/m²·d and being composed of a ceramic material and/or a low melting point glass.

According to another feature of the invention, after step c), a step g) is carried out in which one covers at least the anode connection zone (1002), preferably at least the first longitudinal face (F6) comprising at least the anode connection zone (1002), by an anode contact member (97′), capable of ensuring the electrical contact between the stack (I) and an outer conductive element, and in that one covers at least the cathode connection zone (1006), preferably at least the second longitudinal face (F4) comprising at least the cathode connection zone (1006), by a cathode contact member (97″) capable of ensuring the electrical contact between the stack (I) and an outer conductive element, step (i) comprising: the deposition on at least the anode connection zone (1002) and on at least the cathode connection zone (1006), preferably, on at least the first longitudinal face (F6) comprising at least the anode connection zone (1002), and on at least the second longitudinal face (F4) comprising at least the cathode connection zone (1006), of a first electrical connection layer of material loaded with electrically conductive particles, the first layer being preferably formed of polymeric resin and/or a material obtained by a sol-gel method loaded with electrically conductive particles.

Optionally, when the first layer is formed of polymeric resin and/or a material obtained by a sol-gel method loaded with electrically conductive particles, a drying step followed by a step of polymerisation of the polymeric resin and/or the material obtained by a sol-gel method; and the deposition, on the first layer, of a second electrical connection layer comprising a metal foil disposed on the first electrical connection layer.

Optionally, the deposition on the second electrical connection layer, of a third electrical connection layer comprising a conductive ink.

According to yet another feature of the invention, the cuts made in step d) when this step is carried out, and/or in step c), are performed by laser ablation, preferably in that all cuts made in step d) when this step is carried out, and/or in step c) are performed by laser.

The invention also relates to a battery (1000) comprising at least one anode entity (110) and at least one cathode entity (140), disposed one above the other in an alternating manner in a frontal direction (ZZ) to the main plane of the battery (1000), forming a stack (I), in which the anode entity (110) comprises: an anode current collector substrate (10), at least one anode layer (20), and possibly a layer of an electrolyte material (30) or a separator (31) impregnated with an electrolyte, and in which the cathode entity (140) comprises: a cathode current collector substrate (40), at least one cathode layer (50), and possibly a layer of an electrolyte material (30) or a separator (31) impregnated with an electrolyte.

The battery (1000) has six faces, namely, two faces called front faces (F1, F2) which are mutually opposite, in particular mutually parallel, generally parallel to each anode entity (110), to each cathode entity (140), to the anode current collector substrate(s) (10), to the anode layer(s) (20), to the layer(s) of an electrolyte material (30) or to the layer(s) of separator impregnated with an electrolyte (31), to the cathode layer(s) (50), and to the cathode current collector substrate(s) (40), two faces called lateral faces (F3, F5) which are mutually opposite, in particular mutually parallel, and two faces called longitudinal faces (F4, F6), which are mutually opposite, in particular mutually parallel.

Given that the first longitudinal face (F6) of the battery comprises at least one anode connection zone (1002) and that a second longitudinal face (F4) of the battery comprises at least one cathode connection zone (1006), the anode (1002) and cathode (1006) connection zones being laterally opposite, such that: each anode entity (110) and each cathode entity (140) comprises a respective primary body (111, 141), separated from a respective secondary body (112, 142) by a free space (113, 143) of any material of electrode, electrolyte and current collector substrate. When the battery comprises several free spaces (113), in a frontal direction (ZZ) to the main plane of the battery, the free spaces formed between each primary body (111) and each secondary body (112) of each anode entity (110) are superimposed, the free spaces formed between each primary body (141) and each secondary body (142) of each anode entity (110) are superimposed, and the free spaces of each anode entity (110) and each cathode entity (140) are not coincident.

The battery comprises an encapsulation system covering at least in part the outer periphery of the stack (I), the encapsulation system (95) covering the front faces of the stack (F1, F2), the lateral faces (F3, F5) and at least in part the longitudinal faces (F4, F6) such that only the anode (1002) and cathode (1006) connection zones, preferably, the first longitudinal face (F6) comprising at least the anode connection zone (1002), and the second longitudinal face (F4) comprising at least the cathode connection zone (1006), are not covered with the encapsulation system (95).

The encapsulation system (95) comprises: optionally, a first cover layer, preferably selected from parylene, parylene type F, polyimide, epoxy resins, silicone, polyamide, sol-gel silica, organic silica and/or a mixture thereof, deposited on at least part of the outer periphery of the stack (I), optionally a second cover layer composed of an electrically insulating material deposited by deposition of atomic layers, on at least part of the outer periphery of the stack (I), or on the first cover layer, at least one third waterproof cover layer, preferably having a water vapor permeance (WVTR) of less than 10⁻⁵ g/m²·d, this third cover layer being composed of a ceramic material and/or a low melting point glass, preferably a glass whose melting point is less than 600° C., deposited on at least part of the outer periphery of the stack (I), or on the first cover layer. Given that when the second cover layer is present, a succession of the second cover layer and the third cover layer can be repeated z times with z≥1 and deposited on the outer periphery of at least the third cover layer, the last layer of the encapsulation system being a waterproof cover layer, preferably having a water vapor permeance (WVTR) of less than 10⁻⁵ g/m²·d and being composed of a ceramic material and/or a low melting point glass.

According to an advantageous feature of the battery in accordance with the invention, the anode connection zone (1002), preferably the first longitudinal face (F6) comprising at least the anode connection zone (1002), is covered by an anode contact member (97′), and at least the cathode connection zone (1006), preferably the second longitudinal face (F4) comprising at least the cathode connection zone (1006), is covered by a cathode contact member (97″), given that the anode (97′) and cathode (97″) contact members are capable of ensuring the electrical contact between the stack (I) and an outer conductive element.

According to another feature of the battery in accordance with the invention, each of the anode (97′) and cathode (97″) contact members comprises: a first electrical connection layer, disposed on at least the anode connection zone (1002) and at least the cathode connection zone (1006), preferably on the first longitudinal face (F6) comprising at least the cathode connection zone (1002) and on the second longitudinal face (F4) comprising at least the cathode connection zone (1006), the first electrical connection layer comprising a material loaded with electrically conductive particles, preferably a polymeric resin and/or a material obtained by a sol-gel method, loaded with electrically conductive particles and even more preferably a polymeric resin loaded with graphite, and a second electrical connection layer comprising a metal foil disposed on the first layer of material loaded with electrically conductive particles.

According to a first embodiment, the battery in accordance with the invention has a capacity less than or equal to 1 mA h.

According to an alternative embodiment, the battery in accordance with the invention has a capacity greater than 1 mA h.

### DRAWINGS

The appended figures, given by way of non-limiting examples, represent different aspects and embodiments of the invention.

FIG. 1 is a perspective view of anode and cathode foils intended to form a stack according to the battery manufacturing method in accordance with the invention, these anode and cathode foils having empty zones, called small empty zones, i.e. slots.

FIG. 2 is a top view, illustrating one of the foils, in particular an anode foil, of FIG. 1.

FIG. 3 is a top view, illustrating the stack of anode and cathode foils as well as the small empty zones, i.e. slots formed in adjacent foils, according to the invention.

FIG. 4 is a top view, on a larger scale, illustrating emp small empty zones, i.e. slots formed in adjacent foils, according to the invention.

FIG. 5 is a perspective view, also on a large scale, illustrating these small empty zones, i.e. these slots formed in adjacent foils.

FIG. 6 is a top view, illustrating a cutting step carried out on different slots formed in the stack of the previous figures.

FIG. 7 is a top view, illustrating a line of batteries according to the invention obtained after cutting the stack according to the cutting lines DXn and DX′n.

FIG. 8 is a sectional view, along the section line VIII-VIII which corresponds to the cutting line DX′ₙ, indicated in FIG. 6 illustrating the stack, according to the invention, of anode and cathode foils having slots.

FIG. 9 is a sectional view, along the section line VIII-VIII which corresponds to cutting line DX′ₙ, indicated in FIG. 6 illustrating the stack, according to the invention, of anode and cathode foils having slots as well as the primary anode body, the secondary anode body, the primary cathode body and the secondary cathode body.

FIG. 10 is a perspective view with tearing illustrating a line of batteries in accordance with the invention encapsulated in an encapsulation system, which is obtainable in particular according to the method of the preceding figures.

FIG. 11 is a perspective view with tearing illustrating a battery in accordance with the invention comprising an encapsulation system, which is obtainable in particular according to the method of the preceding figures.

FIG. 12 is a perspective view with tearing illustrating a battery in accordance with the invention comprising an encapsulation system, which is obtainable in particular according to the method of the preceding figures and illustrating the stack as well as the anode primary body, the anode secondary body, the cathode primary body and the cathode secondary body.

FIG. 13 is a sectional view, along the section line VIII-VIII or the cutting line DX′ₙ, illustrating a battery in accordance with the invention comprising an encapsulation system and contact members, which is obtainable in particular according to the method of the preceding figures.

FIG. 14 is a perspective view illustrating a battery with tearing according to the prior art.

FIG. 15 is a top view, illustrating the stack of anode and cathode foils as well as the zones called large empty zones, i.e. the notches made in adjacent foils, according to a first variant of the invention.

FIG. 16 is a top view, illustrating a cutting step carried out on different notches formed in the stack of the previous figure according to the first variant of the invention, and showing the batteries obtained according to this same variant.

FIG. 17 is a top view, illustrating the stack of anode and cathode strips as well as the spacings provided between adjacent strips, according to a second variant of the invention.

FIG. 18 is a sectional view, along the cutting line DX′ₙ, indicated in FIG. 17 illustrating the stack, according to the second variant of the invention.

FIG. 19 is a top view, similar to FIG. 6, illustrating a variant of the slots formed in the stack.

FIG. 20 is a top view, schematically illustrating a battery which is obtainable thanks to a stack provided with slots according to FIG. 19.

FIG. 21 is a top view, similar to FIG. 19, illustrating a variant of slots, which does not belong to the present invention.

### DESCRIPTION

One associates with this battery, by convention, the following geometric names.

ZZ the direction called frontal direction, namely perpendicular to the plane of the different stacked layers of the battery according to the invention

XX the direction called longitudinal direction, which is included in the plane of the stacked layers and which is parallel to the largest dimension of these layers forming the stack of the battery according to the invention, in top view, namely in the frontal direction

YY the direction called lateral or transverse direction, which is included in the plane of the stacked layers and which is parallel to the smallest dimension of these layers, in top view.

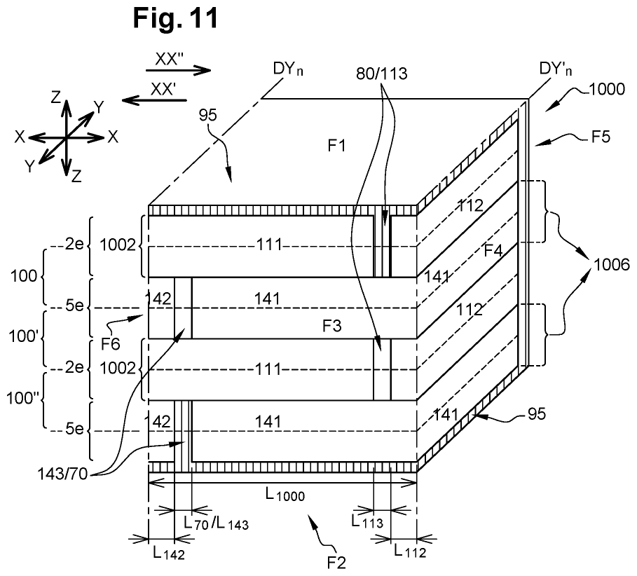

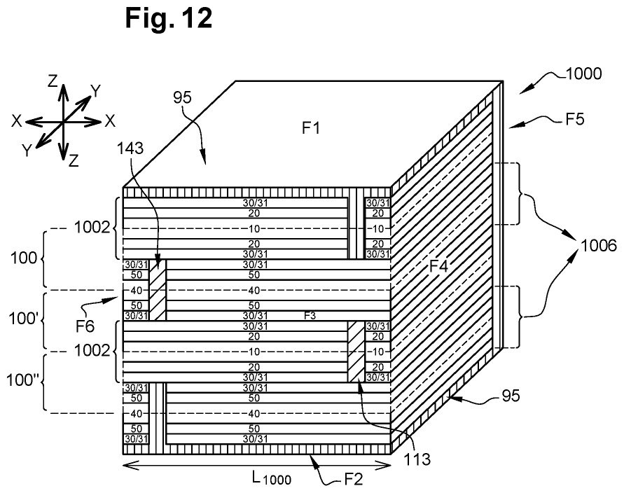

Also by convention, the two orientations associated with each of these three directions are given with reference to the plane of the foil on which FIG. 11 or FIG. 12 is reproduced.

For the direction XX, one therefore associates the rightward orientation and the leftward orientation, for the direction YY, one associates the forward orientation and the backward orientation, and for the direction ZZ, one associates the upward orientation and the downward orientation, with reference to the plane of the foil on which FIG. 11 or FIG. 12 is reproduced.

Also by convention, one defines a first longitudinal orientation XX′ directed from right to left and a second longitudinal orientation XX″, opposite to the first longitudinal orientation XX′, namely directed from left to right, with reference to the plane of the foil on which FIG. 11 or FIG. 12 is reproduced. One defines, always with reference to the plane of the foil on which FIG. 11 or FIG. 12 is reproduced, a first lateral orientation YY′ directed from front to rear, a second lateral orientation YY″, opposite to the first lateral orientation, a first frontal orientation ZZ′ directed from the top to the bottom, as well as a second frontal orientation ZZ″, opposite to the first frontal orientation.

In order to characterise the barrier properties of an encapsulation system, one refers, in the present description, to the WVTR coefficient (Water Vapor Transmission Rate) which characterises the water vapor permeance of an encapsulation system. The lower the WVTR coefficient, the more waterproof the encapsulation system. The water vapor permeance (WVTR) can be determined using a method which is the subject of the U.S. Pat. No. 7,624,621 and which is also described in the publication “Structural properties of ultraviolet cured polysilazane gas barrier layers on polymer substrates” by A. Morlier et al., published in the journal Thin Solid Films 550 (2014) 85-89.

The present invention aims at manufacturing of a battery as shown in FIG. 11 and FIG. 12. With reference to FIGS. 11 & 12, there is illustrated one 1000 of the batteries according to the invention comprising at least one anode entity 110 and at least one cathode entity 140, disposed one above the other in an alternating manner in a frontal direction ZZ of the battery 1000. Each anode entity 110 of the battery 1000 according to the invention comprises, IN the frontal direction ZZ of the battery 1000, an anode current collector substrate 10, at least one anode layer 20, and possibly a layer of an electrolyte material 30 or a separator 31 impregnated with an electrolyte. Each cathode entity 140 of the battery 1000 according to the invention comprises, according to the frontal direction ZZ of the battery 1000, a cathode current collector substrate 40, at least one cathode layer 50, and possibly a layer of an electrolyte material 30 or a separator 31 impregnated with an electrolyte.

As illustrated in FIG. 11, the battery 1000 according to the invention has six faces. One defines: two faces called front faces F1, F2 which are mutually opposite, in the example mutually parallel, generally parallel to each anode entity 110 and, to each cathode entity 140, two faces called lateral faces F3, F5 which are mutually opposite, in the example mutually parallel; and two faces called longitudinal faces F4, F6, which are mutually opposite, in the example mutually parallel.

As represented in FIG. 11, the first longitudinal face F6 of the battery 1000 comprises at least one anode connection zone 1002. The second longitudinal face F4 of the battery 1000 comprises at least one cathode connection zone 1006. In this manner, the anode 1002 and cathode 1006 connection zones are laterally opposite. Moreover, each anode entity 110 and each cathode entity 140 comprises, in a longitudinal direction XX of the battery 1000, a respective primary body 111, 141, separated from a respective secondary body 112, 142 by a free space 113, 143 of any material of electrode, electrolyte and current collector substrate. Thus, for each cathode entity 140, the primary body 141, the free space 143 of any material of electrode, electrolyte and current collector substrate, and the secondary body 142 are disposed next to each other in a first longitudinal direction XX′ of the battery 1000. Similarly, for each anode entity 110, the primary body 111, the free space 113 of any material of electrode, electrolyte and current collector substrate, and the secondary body 112 are disposed next to each other in a second longitudinal direction XX″, opposite to the first longitudinal direction XX′, of the battery 1000

As represented in FIG. 11, the battery 1000 according to the invention comprises, by way of non-limiting example, several free spaces 113, 143, in the frontal direction ZZ of the battery. In this manner, in top view, the free spaces formed between each primary body 111 and each secondary body 112 of each anode entity 110 are superimposed, and the free spaces formed between each primary body 141 and each secondary body 142 of each cathode entity 140 are superimposed. Moreover, the free spaces 113, 143 of each anode unit 110 and each cathode unit 140 are not coincident.

The battery according to the invention is formed from a stack I comprising, in the longitudinal direction XX, x rows with x strictly greater than 1 as well as y line(s) with y greater than or equal to 1, so as to form a number (x*y) of batteries. The stack I is formed by an alternating succession of strata respectively cathode SC, SC₁, SC₂, . . . SCₙ and anode SA, SA₁, SA₂, . . . SAₙ strata, each cathode stratum SC, SC₁, SC₂, . . . SCₙ being intended to form a number (x*y) of cathode entities 140 while each anode stratum SA, SA₁, SA₂, . . . SAₙ is intended to form a number (x*y) of anode entities 110.

Each anode stratum SA, SA₁, SA₂, . . . SAₙ of the stack I according to the invention comprises, in the frontal direction ZZ of the stack I, parallel to the frontal direction ZZ of the final battery 1000, an anode current collector substrate 10, at least one anode layer 20, and possibly a layer of an electrolyte material 30 or a separator 31 impregnated with an electrolyte.

Each cathode stratum SC, SC₁, SC₂, . . . SCₙ of the stack I according to the invention comprises, in the frontal direction ZZ of the stack I, parallel to the frontal direction ZZ of the final battery 1000, a cathode current collector substrate 40, at least one cathode layer 50, and possibly a layer of an electrolyte material 30 or a separator 31 impregnated with an electrolyte.

Each stratum SA, SA₁, SA₂, . . . SAₙ, SC, SC₁, SC₂, . . . SCₙ comprises: a plurality of primary preforms 111′, 141′, respectively anode 111′ and cathode 141′ primary preforms, each of which is intended to form a respective primary body 111, 141, a plurality of secondary preforms 112′, 142′, respectively anode 112′ and cathode 142′ secondary preforms, each of which is intended to form a respective secondary body 112, 142.

The primary preform 111′, 141′ and the secondary preform 112′, 142′ being mutually separated by a zone called empty zone 80″, 70″, which is intended to form at least one of the free spaces 113, 143 of the battery 1000.

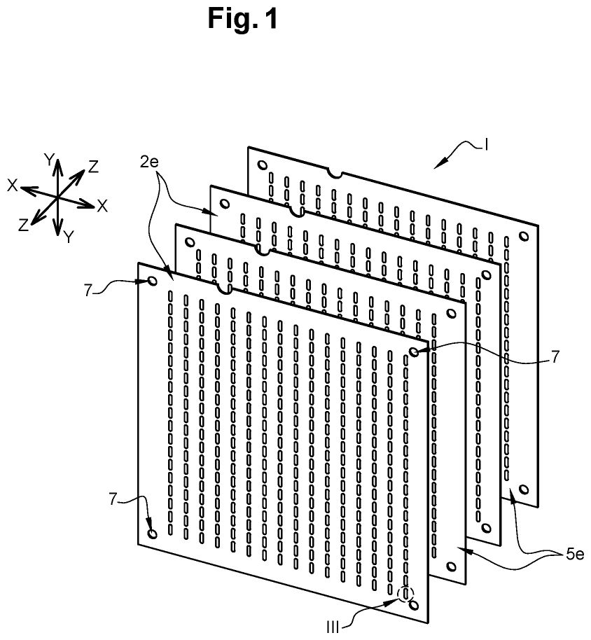

According to the first embodiment of the invention, the method in accordance with the invention comprises firstly a step in which a stack I of alternating strata SA, SA₁, SA₂, . . . SAₙ, SC, SC₁, SC₂, . . . SCₙ is made. In this first embodiment, each of these strata is a foil made in one piece. In the following, these different foils are called, as the case, “anode foils” or “cathode foils”. As will be seen in more detail, each anode foil is intended to form the anode of several batteries, and each cathode foil is intended to form the cathode of several batteries. In the example illustrated in FIG. 1, there were represented two cathode foils, having small empty zones, i.e. slots 5e, as well as two anode foils having small empty zones, i.e. slots 2e. In practice, this stack is formed by a higher number of foils, typically comprised between ten and a thousand. The number of cathode foils having slots 5e is identical to the number of anode foils having slots 2e which are used constituting the stack I of alternating foils of opposite polarity.

In an advantageous embodiment, each of these foils has perforations 7 at the four corners thereof so that when these perforations 7 are superimposed, all cathodes and all anodes of these foils are arranged according to the invention, as this will be explained in greater detail hereinafter (see FIGS. 1, 2, 3 and 15). These perforations 7 can be made by any appropriate means, in particular on anode and cathode foils after manufacture, or on substrate foils 10, 40 before manufacture of the anode and cathode foils.

Each anode foil comprises an anode current collector substrate 10 coated with an active layer of an anode material 20, hereinafter anode layer 20. Each cathode foil comprises a cathode current collector substrate 40 coated with an active layer 20 of a cathode material 50, hereinafter referred to as cathode layer 50. Each of these active layers can be solid, and more particularly of dense or porous nature. Moreover, in order to avoid any electrical contact between two active layers of opposite polarities, an electrolyte layer 30 or a layer of separator 31 which is subsequently impregnated with an electrolyte is disposed on the active layer of at least one of these current collector substrates previously coated with the active layer, in contact with the opposite active layer. The electrolyte layer 30 or the separator layer 31, may be disposed on the anode layer 20 and/or on the cathode layer 50; the electrolyte layer 30 or the separator layer 31 is an integral part of the anode foil and/or the cathode foil comprising it.

Advantageously, the two faces of the anode 10, respectively cathode 40, current collector substrate are coated with an anode layer 20, respectively with a cathode layer 50, and optionally with an electrolyte layer 30 or a separator layer 31, disposed on the anode layer 20, respectively on the cathode layer 50. In this case, the anode 10, respectively cathode 40, current collector substrate serves as a current collector for two adjacent unit cells 100, 100′. The use of these substrates in the batteries allows increasing the production efficiency of rechargeable batteries with high energy density and high power density.

The mechanical structure of one of the anode foils is described hereinafter, given that the other anode foils have an identical structure. Moreover, as will be seen in what follows, the cathode foils have a structure similar to that of the anode foils.

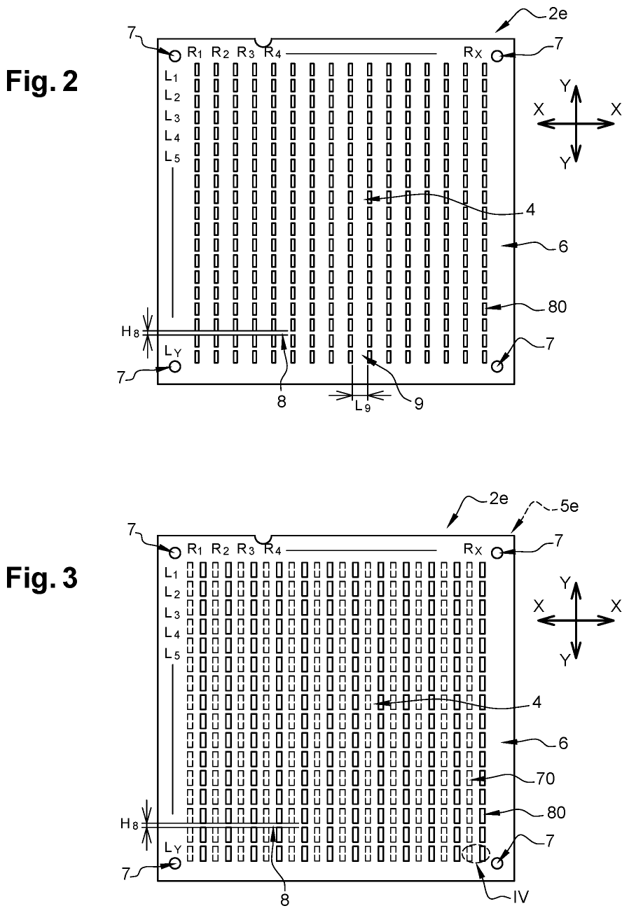

As shown in FIG. 2, the anode foil 2e having slots 80 has a quadrilateral shape, substantially of rectangular type. It delimits a central zone called perforated central zone 4, in which slots 80 are formed, i.e. empty zones called small empty zones, free of any material of electrode, electrolyte and current collector substrate, which will be described hereinafter. With reference to the positioning of these slots, a direction called lateral or transverse direction YY of the foil, which corresponds to the lateral direction of these slots 80, as well as a direction called horizontal direction XX of the foil, perpendicular to the direction YY have been defined. The central zone 4 is bordered by a peripheral frame 6 which is solid, namely devoid of slots 80. The function of this frame 6 is in particular to ensure an easy handling of each foil.

The slots 80 are distributed along lines L₁ to L_{y}, disposed one below the other, as well as along rows R₁ to Rₓ provided next to each other. By way of non-limiting examples, in the context of the manufacture of surface mounted component type microbatteries (hereinafter SMC), the used anode and cathode foils can be plates of 100 mm×100 mm. Typically, the number of lines of these foils is comprised between 10 and 500, while the number of rows is comprised between 10 and 500. Depending on the desired capacity of the battery, these dimensions may vary and the number of lines and rows by anode and cathode foils can be adapted accordingly. The dimensions of the used anode and cathode foils can, in other words, be modulated according to the needs. As shown in FIG. 2, two adjacent lines can be separated by material bridges 8, the width of which is noted 18, which is comprised between 0.05 mm and 5 mm. Two adjacent rows can be separated by second material bridges 9, the length of which is denoted L₉, which is comprised between 0.05 mm and 5 mm. These material bridges 8, 9 of anode and cathode foil give these foils a sufficient mechanical rigidity so that they can be easily handled.

The slots 70, 80 are through slots, namely that they open onto the opposite faces, respectively upper and lower faces of the foil, as will be seen in more detail hereinafter. These slots 70, 80 preferably have a quadrilateral shape, typically of rectangular type. In the illustrated example, these slots each have an I-shape, which makes them very easy to use. These slots 70, 80 can be made in a manner known per se, directly on the current collector substrate, before any deposition of anode or cathode materials by chemical etching, by electroforming, by laser cutting, by microperforation or by stamping.

These slots 70, 80 can also be made: on current collector substrates coated with an anode or cathode material layer, or on current collector substrates coated with an anode or cathode material layer, itself coated with an electrolyte layer or a separator layer, i.e. on anode or cathode foils.

When the slots 70, 80 are made on such coated substrates, the slots 70, 80 can be made in a manner known per se, for example by laser cutting (or laser ablation), by femtosecond laser cutting, by microperforation or by stamping.

As illustrated in FIG. 3, each cathode foil is also provided with different lines and rows of cathode slots 70, provided in the same number as the anode slots 80 of each anode foil. The cathode foil obtained after making slots 70, is hereinafter called cathode foil having slots 5e.

In top view and as illustrated in FIG. 3, the cathode slots 70 made in all cathode foils 5e are coincident, i.e. are mutually superimposed. Similarly, the anode slots 80 made in all anode foils 2e are coincident, i.e. are mutually superimposed.

One will now describe the slots 70, 80 as illustrated in FIGS. 3, 4, and 5, given that all slots 80 of the anode foil are identical and that all slots 70 of the cathode foil are identical.

Each anode slot 80 has, preferably, a quadrilateral shape, typically of rectangular type. It bears noting: I₈₀ the width of the entire anode slot 80, which is typically comprised between 0.25 mm and 10 mm; and L₈₀ the length thereof which is typically comprised between 0.01 mm and 0.5 mm.

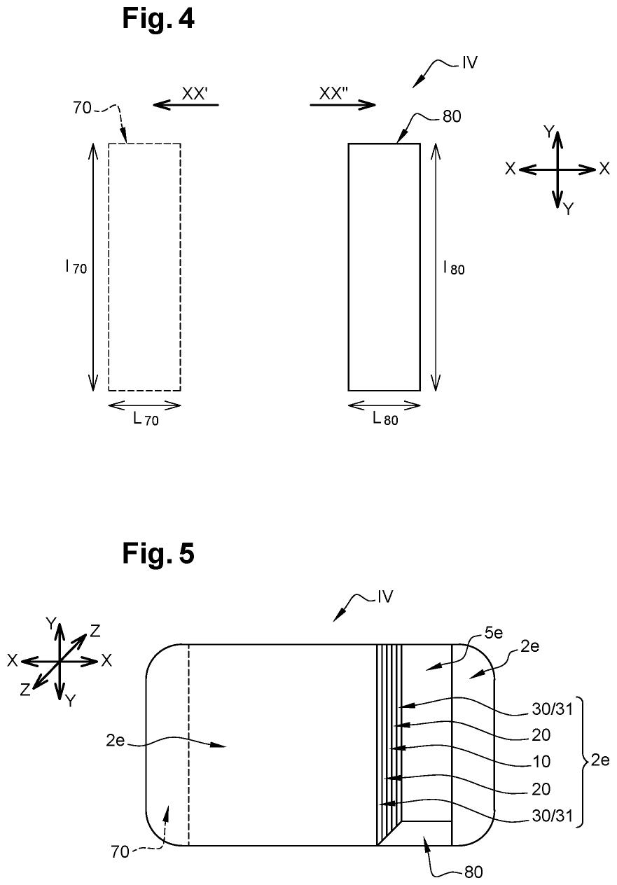

As shown in particular in FIGS. 4 and 5, the structure of each cathode slot 70 is substantially similar to that of each anode slot 80, namely that each cathode slot 70 preferably has a quadrilateral shape, typically of rectangular type. The dimensions of the cathode slots 70 are preferably identical to those of the anode slots 80. It bears further noting: I₇₀ the width of the entire cathode slot 70, which is typically comprised between 0.25 mm and 10 mm; and L₇₀ the length thereof which is typically comprised between 0.01 mm and 0.5 mm.

As seen above, the structures of the anode 80 and cathode 70 slots are similar. Moreover, in top view, the anode slots 80 are offset relative to the cathode slots 70, in the longitudinal direction XX. In this manner, in top view, the anode 80 and cathode 70 slots are not coincident and are distinct from each other.

The stack I comprises an alternating arrangement of at least one anode foil 2e having slots 80 and of at least one cathode foil 5e having slots 70. Thus, at least one unit cell 100 is obtained, comprising successively an anode current collector substrate 10, an anode layer 20, a layer of an electrolyte material 30 and/or a separator layer 31 subsequently impregnated with an electrolyte, a cathode layer 50, and a cathode current collector substrate 40.

This stack I is made such that in a top view: the cathode slots 70 made in all cathode foils 5e are coincident, i.e. are mutually superimposed, the anode slots 80 made in all anode foils 2e are coincident, i.e. are mutually superimposed, and the anode 80 and cathode 70 slots are not coincident and are distinct from each other.

In the case where the battery comprises a plurality of unit cells 100, 100′, 100″, the unit cells 100, 100′, 100″ are disposed one below the other, namely superimposed in a frontal direction ZZ to the main plane of the battery as represented in FIG. 11, such that, preferably: the anode current collector substrate 10 is the anode current collector substrate 10 of two adjacent unit cells 100, 100′, 100″, and the cathode current collector substrate 40 is the cathode current collector substrate 40 of two adjacent unit cells 100, 100′, 100″.

It is assumed that the stack I, described above, is subjected to steps aimed at ensuring the overall mechanical stability thereof. These steps, of a type known per se, include in particular the heat and/or mechanical treatment of the various different foils 2e, 5e having slots 80, 70. As will be seen below, this stack thus consolidated allows the formation of individual batteries, whose number is equal to the product between the number of lines Y and the number of rows X.

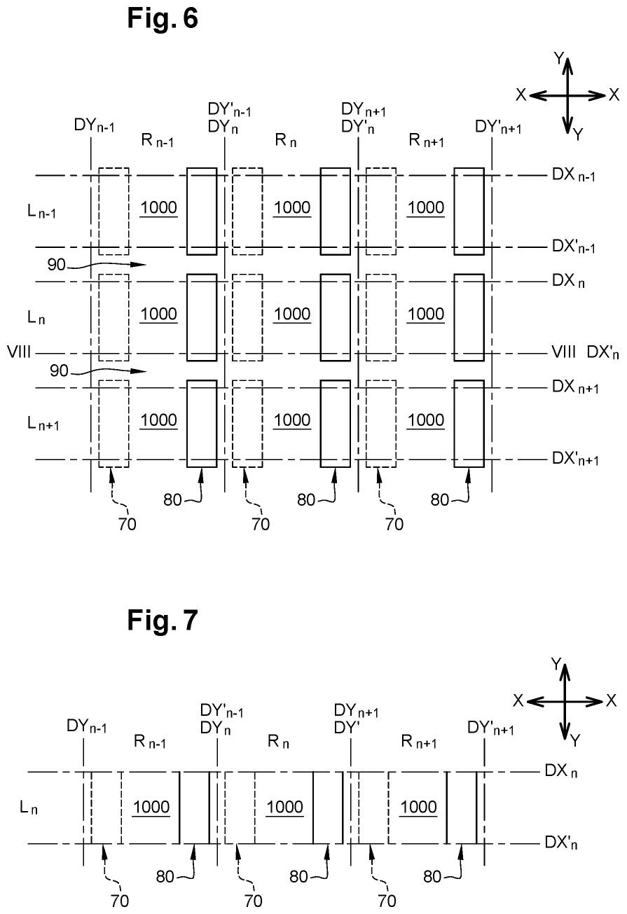

To this end, with reference to FIG. 6, three lines Lₙ₋₁ to Lₙ₊₁ have been illustrated, as well as three rows Rₙ₋₁ to Rₙ₋₁. In the following, one calls battery line a line, belonging to the stack, which is intended to form several batteries. The number of batteries formed, for a given line, corresponds to the number of rows of the stack. In accordance with the invention, and when the stack I comprises several lines also called hereinafter battery lines Lₙ, a first pair of cuts DXₙ and DX′ₙ is made, allowing separating a line Lₙ of batteries 1000 given relative to at least one other line Lₙ₋₁, Lₙ₊₁ of batteries formed from the consolidated stack, as represented in FIG. 7. Each cut, which is performed right through, namely which extends over the entire height of the stack, is carried out in a manner known per se. By way of non-limiting examples, mention will be made of cutting by sawing, in particular dicing, guillotine cutting or even laser cutting. In addition, the zones 90 of the foils of the stack, which do not form the batteries, have been illustrated with a dotted filling, while the volume of the slots is left blank.

As shown in particular in FIG. 6, which is a view on a larger scale of the slots formed in adjacent foils of FIG. 3, each cut DXₙ, DX′ₙ is made in the frontal direction ZZ of the battery, indifferently in either orientations. The cuts DXₙ and DX′ₙ are, preferably, mutually parallel and are, preferably, made perpendicular to both the alignment of the anode slots 80 and the cathode slots 70. The cuts DXₙ and DX′n are made over the entire height of the stack through the anode slots 80 and cathode slots 70, and this so as to limit the material falls 90.

With reference again to FIG. 6, each final battery is delimited, at the rear and at the front, by the first pair of cuts DXₙ and DX′ₙ, preferably mutually parallel, and, on the left and on the right by a second pair of cuts DYₙ and DY′ₙ, preferably mutually parallel. In FIG. 6, the batteries 1000 have been represented in hatched manner, once obtained according to the first pair of cuts DXₙ and DX′n and according to the second pair of cuts DYₙ and DY′ₙ.

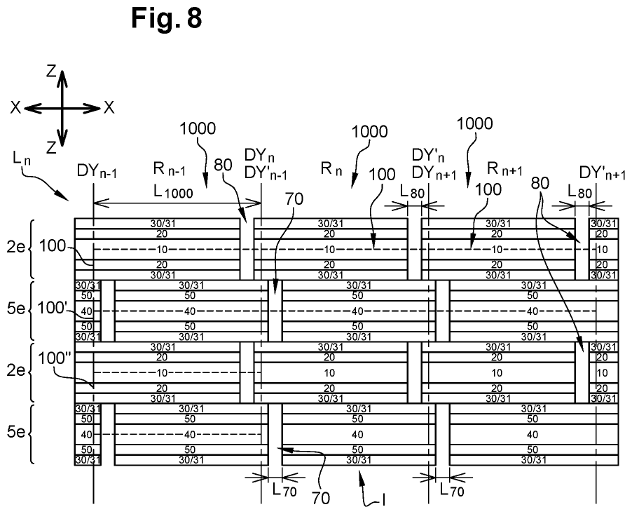

FIG. 8 is a sectional view, taken along the section line VIII-VIII corresponding to the cutting line DXₙ as indicated in FIG. 6, which extends through line Lₙ of batteries. In FIG. 8, there is represented the alternating arrangement of two anode foils having slots 2e and two cathode foils having slots 5e. In the same figure, the slots 70, 80, also illustrated in FIG. 6, as well as adjacent unit cells, are referenced according to an advantageous embodiment of the invention.

The anode foil 2e having small empty zones, i.e. slots comprises an anode current collector substrate 10 coated with an anode layer 20, itself optionally coated with an electrolyte layer 30 or a layer of separator 31 subsequently impregnated with an electrolyte. Each cathode foil 5e having small empty zones, ie slots comprises a cathode current collector substrate 40 coated with an active layer of a cathode material 50, itself optionally coated with an electrolyte layer 30 or a layer of separator 31 subsequently impregnated with an electrolyte. In order to avoid any electrical contact between two active layers of opposite polarity, i.e. between the anode layer 20 and the cathode layer 50, at least one electrolyte layer 30 and/or at least one layer of separator 31 impregnated or subsequently impregnated with an electrolyte is/are disposed. In FIG. 8 a unit cell 100 is represented, comprising successively an anode current collector substrate 10, an anode layer 20, at least one layer of an electrolyte material 30 or a layer of separator 31 impregnated or subsequently impregnated with an electrolyte, a cathode layer 50, and a cathode current collector substrate 40.

Advantageously, the anode current collector substrate 10 of a unit cell 100′ can be joined to the anode current collector substrate 10 of the adjacent unit cell 100″. Similarly, the cathode current collector substrates of two adjacent unit cells 100, 100′ can be joined to each other.

In an advantageous embodiment, the anode 10, respectively cathode 40, current collector substrate can serve as a current collector for two adjacent unit cells, as illustrated in particular in FIG. 8. As explained previously, the two faces of the anode 10, respectively cathode 40, current collector substrate are coated with an anode layer 20, respectively with a cathode layer 50, and optionally coated with an electrolyte layer 30 or a separator layer 31, disposed on the anode layer 20, respectively on the cathode layer 50. This allows increasing the production efficiency of the batteries.

As represented in FIG. 8, each anode foil having slots 2e and each cathode foil having slots 5e are arranged so that in a top view: the cathode slots 70 made in all cathode foils 5e are coincident, i.e. are mutually superimposed, the anode slots 80 made in all anode foils 2e are coincident, i.e. are mutually superimposed, and the anode 80 and cathode 70 slots are not the coincident and are distinct from each other.

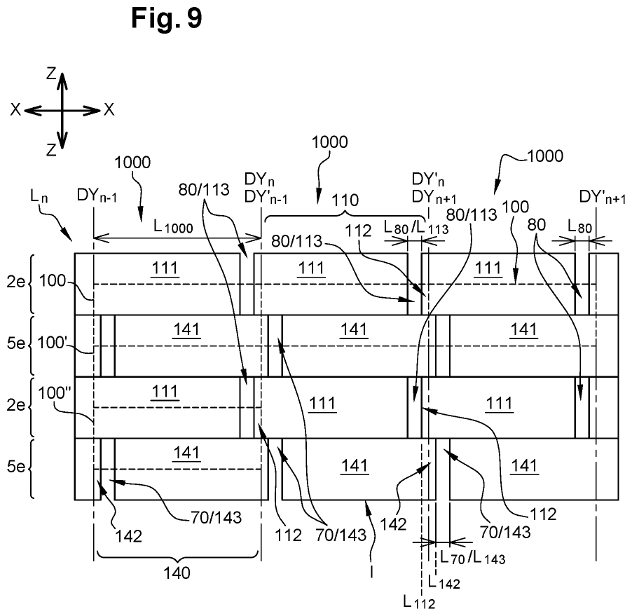

In FIG. 9, there is shown the alternating arrangement of two anode foils having slots 2e and two cathode foils having slots 5e. In the same figure, one referenced cutting lines DYₙ, DY′ₙ allowing separating a battery 1000 from the other batteries of a line Lₙ of batteries, the length of a battery L₁₀₀₀, the slots 70, 80, also illustrated in FIG. 6, as well as adjacent unit cells according to an advantageous embodiment of the invention. In FIG. 9, just like in FIG. 8, one notes that the second pair of cuts DYₙ, DY′ₙ is made both through anode entities 110 and cathode entities 140, namely: at a distance L₁₄₂ from the cathode slots 70 so as to have for each cathode entity 140 of the battery 1000 a primary body 141 separated from a secondary body 142 by a free space 143, 70 of any material of electrolyte, separator, current collector substrate and electrode, in particular of cathode, and at a distance L₁₁₂ from the anode slots 80 so as to have for each anode entity 110 of the battery 1000 a primary body 111 separated from a secondary body 112 by a free space 113, 80 of any material of electrolyte, separator, current collector substrate and electrode, in particular of anode.

This feature is particularly advantageous, since it allows improving the quality of the cut relative to the prior art and avoiding the presence of a short-circuit at the longitudinal faces F6, F4 of the battery, avoiding the presence of leakage current, and facilitating electrical contact at the anode 1002 and cathode 1006 connection zones. With reference to FIG. 9, and for each unit battery 1000, it should be noted: the cathode slot 70, corresponding to the free space 143 existing between the primary body 141 and the secondary body 142 of the cathode entity 140; L₇₀, the length of the entire cathode slot 70 which is typically comprised between 0.01 mm and 0.5 mm, this length L₇₀ corresponding to the length L₁₄₃ of the free space 143 existing between the primary body 141 and the secondary body 142 of the cathode entity 140; L₁₄₂, the length of the secondary body 142 of the cathode unit 140, which is typically comprised between XXXX mm and XXXXX mm; the anode slot 80, corresponding to the free space 113 between the primary body 111 and the secondary body 112 of the anode entity 110; L₈₀, the length of the entire anode slot 80 which is typically comprised between 0.01 mm and 0.5 mm, this length L₈₀ corresponding to the length L₁₁₃ of the free space 113 existing between the primary body 111 and the secondary body 112 of the anode entity 110; and L₁₁₂, the length of the secondary body 112 of the anode entity 110, which is typically comprised between 0.01 mm and 0.5 mm.

Advantageously, after making the stack of the anode foils having slots 2e and cathode foils having slots 5e, the stack I is consolidated by heat and/or mechanical treatment (this treatment can be a thermocompression treatment, comprising the simultaneous application of a pressure and a high temperature). The heat treatment of the stack allowing the assembly of the battery is advantageously carried out at a temperature comprised between 50° C. and 500° C., preferably at a temperature below 350° C. The mechanical compression of the stack of the anode foils having slots 2e and cathode foils having slots 5e to be assembled is carried out at a pressure comprised between 10 MPa and 100 MPa, preferably between 20 MPa and 50 MPa.

Making the consolidated stack of foils which constitute the battery has just been described. It is then possible, when the stack I comprises several lines also called hereinafter battery lines Lₙ, to make a first pair of cuts called accessory cuts DXₙ and DX′ₙ allowing separating a given line Lₙ of batteries 1000 from at least one other line Lₙ₋₁, Lₙ₊₁ of batteries formed from the consolidated stack. Each cut, which is performed right through, namely which extends over the entire height of the stack, is carried out in a manner known per se, as indicated above.

When a separator is used as a host matrix of an electrolyte, the previously obtained consolidated stack or the line Lₙ of batteries 1000 can be impregnated when the initial stack I comprises several battery lines Lₙ and a first pair of cuts (DXₙ, DX′ₙ) was made in order to separate the given line (Lₙ) of batteries (1000) from at least one other line (Lₙ₋₁, Lₙ₊₁) of batteries (1000) formed from the consolidated stack. The impregnation of the previously obtained consolidated stack or the line Lₙ of batteries 1000 can be carried out, with a lithium ion carrier phase such as liquid electrolytes or an ionic liquid containing lithium salts, such that the separator layer (31) is impregnated with an electrolyte.

In general, within the scope of the present invention, it is possible to impregnate the separator, but also the electrodes. The structure can also include a combination of impregnated solid and/or mesoporous electrodes and/or can include a solid electrolyte and/or an impregnated separator.

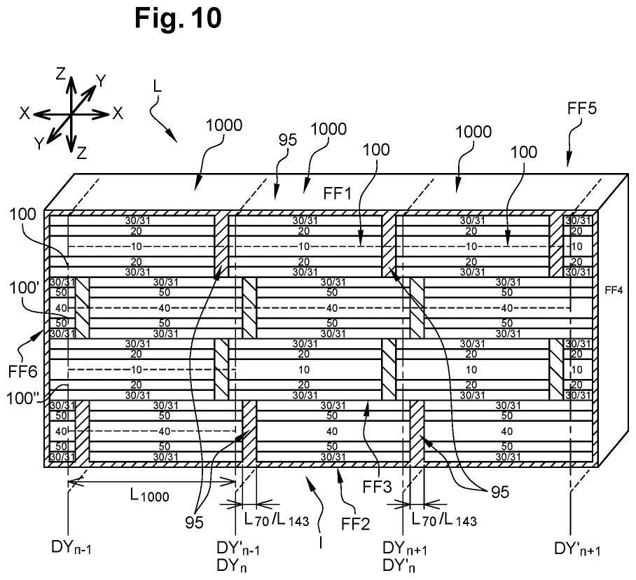

After making a consolidated stack I or a line Lₙ of batteries 1000, possibly impregnated with a lithium ion carrier phase, this stack or this line Lₙ of batteries 1000 is encapsulated by depositing an encapsulation system 95 to ensure the protection of the battery cell from the atmosphere, as represented in FIG. 10.

The battery line Lₙ thus encapsulated has six faces, namely: two faces called front faces FF1, FF2 which are mutually opposite, in the example mutually parallel, generally parallel to the anode entities, generally parallel to the cathode entities, generally parallel to the anode current collector substrate(s) 10, to the anode layer(s) 20, to the layer(s) of an electrolyte material 30 or to the layer(s) of separator impregnated with an electrolyte 31, to the cathode layer(s) 50, and to the cathode current collector substrate(s) 40; two faces called lateral faces FF3, FF5 which are mutually opposite, in particular mutually parallel and parallel to the lateral faces F3, F5 of the battery 1000; and two faces called longitudinal faces FF4, FF6, which are mutually opposite, in particular mutually parallel and parallel to the longitudinal faces F4, F6 of the battery 1000.

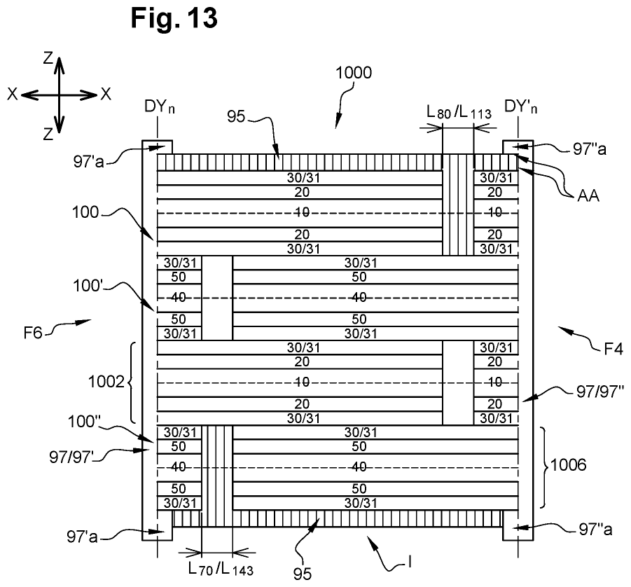

The encapsulation system must advantageously be chemically stable, withstand high temperature and be impermeable to the atmosphere in order to perform its function as a barrier layer. The stack can be covered with an encapsulation system comprising: optionally a first dense and insulating cover layer, preferably selected from parylene, parylene type F, polyimide, epoxy resins, silicone, polyamide, sol-gel silica, organic silica and/or a mixture thereof, deposited on the outer periphery of the stack I of anode 2e and cathode 5e foils, and, preferably, also in the free spaces 113, 143 present between the primary 111, 141 and secondary 112, 142 bodies of each anode entity 110 and each cathode entity 140; optionally a second cover layer composed of an electrically insulating material, deposited by deposition of atomic layers on the outer periphery of the stack I of anode 2e and cathode 5e foils, and, preferably, also in the free spaces 113, 143 present between the primary 111, 141 and secondary 112, 142 bodies of each anode entity 110 and each cathode entity 140, or on the first cover layer; and particularly advantageously, at least one third waterproof cover layer, preferably having a WVTR coefficient of less than 10⁻⁵ g/m²·d. The third cover layer is composed of a ceramic material and/or a low melting point glass, preferably a glass whose melting point is less than 600° C., deposited on the outer periphery of the stack I of anode 2e and cathode 5e foils, and, preferably, also in the free spaces 113, 143 present between the primary 111, 141 and secondary 112, 142 bodies of each anode entity 110 and each cathode entity 140 or on the first cover layer. Given that a sequence of at least one second cover layer and at least one third cover layer can be repeated z times with z 1 and deposited on the outer periphery of at least the third cover layer, and that the last layer of the encapsulation system is a waterproof cover layer, preferably having a WVTR coefficient of less than 10⁻⁵ g/m²·d which is composed of a ceramic material and/or a low melting point glass. This sequence can be repeated z times with z 1. It has a barrier effect, which is all the more significant the higher the value of z. A rigid and waterproof encapsulation is thus obtained, which prevents, in particular, the passage of water vapor at the interface between the encapsulation system and the contact members (see interface AA represented in FIG. 13).

Typically, the first cover layer, which is optional, is selected from the group formed by: silicones (deposited for example by impregnation or by plasma-enhanced chemical vapor deposition from hexamethyldisiloxane (HMDSO)), resins epoxy, polyimide, polyamide, poly-para-xylylene (also called poly (p-xylylene, but better known as parylene), and/or a mixture thereof. When a first cover layer is deposited, it allows protecting the sensitive elements of the battery from its environment. The thickness of the first cover layer is, preferably, comprised between 0.5 μm and 3 μm.

This first cover layer is useful especially when the electrolyte and electrode layers of the battery have porosities: it acts as a planarization layer, which also has a barrier effect. By way of example, this first layer is capable of lining all accessible surfaces of the stack or the line Lₙ of batteries 1000, in particular the outer periphery of the stack or the line line Lₙ of batteries 1000, to close the access of the through-microporosities present on the surface of the stack I or of the line Lₙ of batteries 1000.

In the first cover layer, different variants of parylene can be used. It can be made of parylene type C, parylene type D, parylene type N (CAS 1633-22-3), parylene type F, or a mixture of parylene type C, D, N and/or F. Parylene is a dielectric, transparent, semi-crystalline material which has a high thermodynamic stability, excellent resistance to solvents as well as very low permeability. Parylene also has barrier properties. Within the scope of the present invention, parylene type F is preferred.

This first cover layer is advantageously obtained from the condensation of gaseous monomers deposited by Chemical Vapor Deposition (CVD) on the surfaces of the stack of the battery, which allows having a conformal, thin and uniform covering of all accessible surfaces of the stack. This first cover layer is advantageously rigid; it cannot be considered as a soft surface.

The second cover layer, which is also optional, is composed of an electrically insulating material, preferably inorganic. It is deposited by Atomic Layer Deposition (ALD), by PECVD, by HDPCVD (High Density Plasma Chemical Vapor Deposition) or by ICPCVD (Inductively Coupled Plasma Chemical Vapor Deposition), so as to obtain a conformal covering of all accessible surfaces of the stack which is previously covered with the first cover layer. The layers deposited by ALD are very fragile mechanically and require a rigid bearing surface to ensure their protective role. The deposition of a fragile layer on a flexible surface would lead to the formation of cracks, causing a loss of integrity of this protective layer. Moreover, the growth of the layer deposited by ALD is influenced by the nature of the substrate. A layer deposited by ALD on a substrate having zones of different chemical natures will have an inhomogeneous growth, which may cause a loss of integrity of this protective layer. For this reason, it is preferable for this second optional layer, if it is present, to bear on the first optional layer, which ensures a chemically homogeneous growth substrate.

The ALD deposition techniques are particularly well adapted for covering surfaces having a high roughness in a completely sealed and compliant manner. They allow making conformal layers, free of defects, such as holes (layers called “pinhole free” layers, i.e. free of holes) and represent very good barriers. Their WVTR coefficient is extremely low. The thickness of this second layer is advantageously selected depending on the desired gas tightness level, i.e. the desired WVTR coefficient and depends on the used deposition technique, in particular among ALD, PECVD, HDPCVD and ICPCVD.

The second cover layer can be made of ceramic material, of vitreous material or of glass-ceramic material, for example in the form of oxide, of Al₂O₃, Ta₂O₅, nitride, phosphates, oxynitride, or siloxane type. This second cover layer preferably has a thickness comprised between 10 nm and 5 μm, preferably between 10 nm and 50 nm. The second cover layer deposited by ALD, by PECVD, by HDPCVD or by ICPCVD on the first cover layer allows, on the one hand, ensuring the waterproofness the structure, i.e. preventing the migration of water inside the object and, on the other hand, protecting the first cover layer, preferably of parylene type F, from the atmosphere, in particular air and humidity, thermal exposures in order to avoid its degradation. This second cover layer thus improves the service life of the encapsulated battery. The second cover layer can also be deposited directly on the stack of anode and cathode foils, that is to say in a case where the first cover layer has not been deposited.

The third cover layer must be waterproof and preferably has a WVTR coefficient of less than 10⁻⁵ g/m²·d. This third cover layer being composed of a ceramic material and/or a low melting point glass, preferably a glass whose melting point is less than 600° C., deposited on the outer periphery of the stack of anode and cathode foils or the first cover layer. The ceramic and/or glass material used in this third layer is advantageously selected from: a low melting point glass (typically <600° C.), preferably SiO₂—B₂O₃; Bi₂O₃—B₂O₃, ZnO—Bi₂O₃—B₂O₃, TeO₂—V₂O₅, PbO—SiO₂, and oxides, nitrides, oxynitrides, SiₓN_{y}, SiO₂, SiON, amorphous silicon or SiC. These glasses can be deposited by molding or by dip-coating. The ceramic materials are advantageously deposited by PECVD or preferably by HDPCVD or by ICP CVD at low temperature; these methods allow depositing a layer having good sealing properties.

As represented in particular in FIG. 10, the stack thus encapsulated or the line Lₙ of battery 1000 thus encapsulated, is then cut by any appropriate means according to a second pair of cuts DYₙ and DY′ₙ so as to obtain unit batteries and to expose the anode 1002 and cathode 1006 connection zones of each unit battery 1000.

Advantageously and as represented in FIG. 10, the line Lₙ of batteries 100 is cut according to the cutting pairs DYₙ₋₁ and DY′ₙ₋₁, DYₙ and DY′ₙ, DYₙ₊₁ and DY′ₙ₊₁ so as to obtain unit batteries 1000. In this manner, the cutting lines DY′ₙ₋₁, DYₙ are coincident, just as the cutting lines DY′ₙ and DYₙ₊₁. This allows reducing the number of effective cuts, and thus improving the production efficiency of the batteries.

According to the invention, and in a particularly advantageous manner, the second pair of cuts DYₙ, DY′ₙ as represented in FIG. 11, is made both through anode entities 110 and cathode entities 140, namely: at a distance L₁₄₂ from the cathode slots 70 so as to have for each cathode entity 140 of the battery 1000 a primary body 141 separated from a secondary body 142 by a free space 143, 70 of any material of electrolyte, separator, current collector substrate and electrode, in particular of cathode, and at a distance L₁₁₂ from the anode slots 80 so as to have for each anode entity 110 of the battery 1000 a primary body 111 separated from a secondary body 112 by a free space 113, 80 of any material of electrolyte, separator, current collector substrate and electrode, in particular of anode.

FIGS. 11 and 12 represent a battery with tearing in accordance with the invention. Contact members 97, 97′, 97″ (electrical contacts) are added to where the cathode 1006, respectively anode 1002, connection zones are apparent. These contact zones are preferably disposed on opposite sides of the stack of the battery to collect current (lateral current collectors). The contact members 97, 97′, 97″ are disposed on at least the cathode connection zone 1006 and on at least the anode connection zone 1002, preferably on the face of the encapsulated and cut stack comprising at least the cathode connection zone 1006 and on the face of the coated and cut stack comprising at least the anode connection zone 1002 (see FIG. 13).

Thus, one covers at least the anode connection zone 1002, preferably at least the first longitudinal face F6 comprising at least the anode connection zone 1002, and more preferably the first longitudinal face F6 comprising at least the anode connection zone 1002 as well as the ends 97′a of the faces F1, F2, F3, F5 adjacent to this first longitudinal face F6, by an anode contact member 97′, capable of ensuring the electrical contact between the stack I and an outer conductive element. Moreover, one covers at least the cathode connection zone 1006, preferably at least the second longitudinal face F4 comprising at least the cathode connection zone 1006, and more preferably the second longitudinal face F4 comprising at least the cathode connection zone 1006 as well as the ends 97″a of the faces F1, F2, F3, F5 adjacent to this second longitudinal face F4, by a cathode contact member 97″, capable of ensuring the electrical contact between the stack I and an outer conductive element (see FIG. 13).

Preferably, in the vicinity of the cathode 1006 and anode 1002 connection zones as previously indicated, the contact members 97, 97′, 97″ consist of, a stack of electrical connection layers comprising successively a first electrical connection layer comprising a material loaded with electrically conductive particles, preferably a polymeric resin and/or a material obtained by a sol-gel method, loaded with electrically conductive particles and even more preferably a polymeric resin loaded with graphite, and a second layer consisting of a metal foil disposed on the first electrical connection layer.

The first electrical connection layer allows fastening the second subsequent electrical connection layer while providing “flexibility” to the connectivity without breaking the electrical contact when the electrical circuit is subjected to thermal and/or vibratory stresses.

The second electrical connection layer is advantageously a metal foil. This second electrical connection layer is used to permanently protect the batteries from humidity. In general, for a given thickness of material, metals allow making very waterproof films, more waterproof than those based on ceramics and even more waterproof than those based on polymers which are generally not very hermetic to the passage of water molecules. It allows increasing the calendar service life of the battery by reducing the WVTR coefficient at the contact members.

Advantageously, a third electrical connection layer comprising a conductive ink can be deposited on the second electrical connection layer; it is used to reduce the WVTR coefficient, which increases the service life of the battery.

The contact members 97, 97′, 97″ allow resuming the alternately positive and negative electrical connections on each of the ends. These contact members 97, 97′, 97″ allow making the electrical connections in parallel between the different battery elements. For this, only the cathode connections are available on one end, and the anode connections are available on another end.

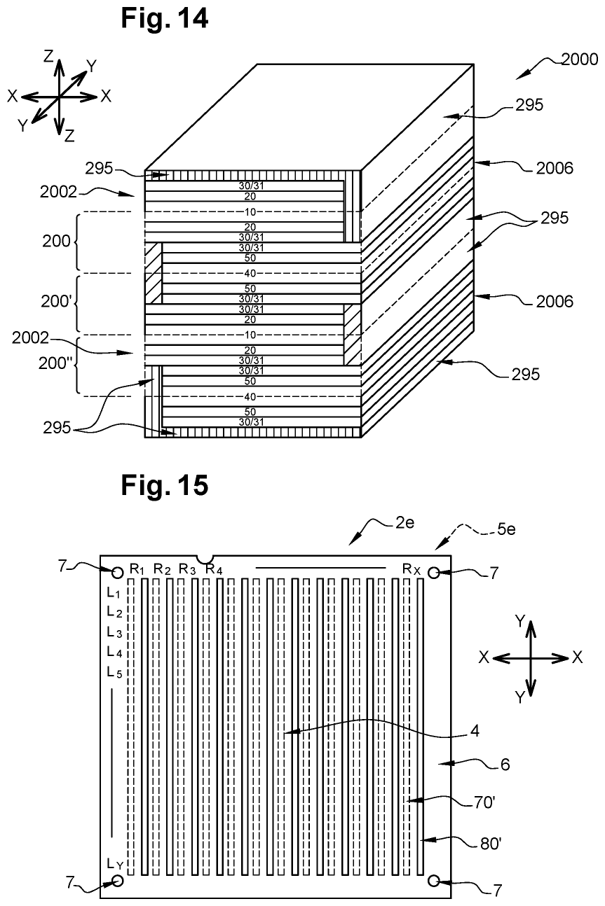

The application WO 2016/001584 describes stacks of several unit cells, consisting of anode and cathode foils stacked alternately and laterally offset (see FIG. 14), encapsulated in an encapsulation system 2095 to ensure the protection of the cell of the battery 2000 from the atmosphere. The cutting of these encapsulated stacks allowing obtaining unit batteries, with exposed anode 2002 and cathode 2006 connections zones, is carried out according to a section plane crossing an alternating succession of electrode and encapsulation system. Due to the difference in density existing between the electrode and the encapsulation system of the battery of the prior art, the cut made according to this section plane induces a risk of tearing of the encapsulation system in the vicinity of the section plane, and thus the creation of short-circuits. In the application WO 2016/001584, during encapsulation, the encapsulation layer fills the interstices of the stack of foils carrying U-shaped cuts. This encapsulation layer introduced at these interstices is thick and does not adhere very well to the stack, inducing this risk of tearing of the encapsulation system 2095 during the subsequent cutting.

According to the present invention, this risk is eliminated with the use of foils according to the invention carrying slots where, in top view: the cathode slots 70 (which will form the free spaces 143, 70 of any material of electrolyte, separator, current collector substrate and electrode, in particular of cathode) made in all cathode foils 5e are coincident, i.e. are mutually superimposed, the anode slots 80 (which will form the free spaces 113, 80 of any material of electrolyte, separator, current collector substrate and electrode, in particular of anode) made in all anode foils 2e are coincident, i.e. are mutually superimposed, and the anode 80 and cathode 70 slots are not the coincident and are distinct from each other.

In this manner, each cathode entity 140 of the battery 1000 comprises a primary body 141 separated from a secondary body 142 by a free space 143, 70 of any material of electrolyte, separator, current collector substrate and electrode, in particular of cathode. Similarly, each anode entity 110 of the battery 1000 comprises a primary body 111 separated from a secondary body 112 by a free space 113, 80 of any material of electrolyte, separator, current collector substrate and electrode, in particular of anode (see FIG. 11).

The heat-pressed mechanical structure of the stack is extremely rigid in the vicinity of the cuts along the cutting lines DY′ₙ and DYₙ, due to the alternating superimposition of cathode and anode foils. The use of such a rigid structure, with the use of foils carrying slots, allows reducing the number of defects during the cuts, increasing the cutting speed, improving the production efficiency of the batteries while minimizing the material falls.

According to the invention, the cuts DY′ₙ and DYₙ are performed through anode foils having slots 2e and cathode foils having slots 5e of comparable density inducing a clean cut of better quality. In addition, the presence of a free space of any material of electrode, electrolyte and/or current collector substrate prevents any risk of short-circuit.

As represented in FIG. 11, each cathode entity 140 includes a primary body 141, a secondary body 142, as well as a space 143 free of any material of electrode, electrolyte and/or current collector substrate. The latter, whose length L₇₀, L₁₄₃ corresponds to that of the cathode slot 70 described above, extends in a lateral direction YY over the entire width of the battery 1000. Similarly, each anode entity 110 comprises a main body 111, a secondary body 112 as well as a space 113 free of any material of electrode, electrolyte and/or current collector substrate. The latter, whose length L₈₀, L₁₁₃ corresponds to that of the anode slot 80 described above, extends in a lateral direction YY over the entire width of the battery 1000.

The anode connection zones 1002 and the cathode connection zones 1006 are preferably laterally opposite as illustrated in FIGS. 11 and 12. The singular structure of the battery according to the invention allows avoiding the presence of a short-circuit at the longitudinal faces F4, F6 of the battery, avoiding the presence of leakage current and facilitating the electrical contact points at the anode 1002 and cathode 1006 connection zones.

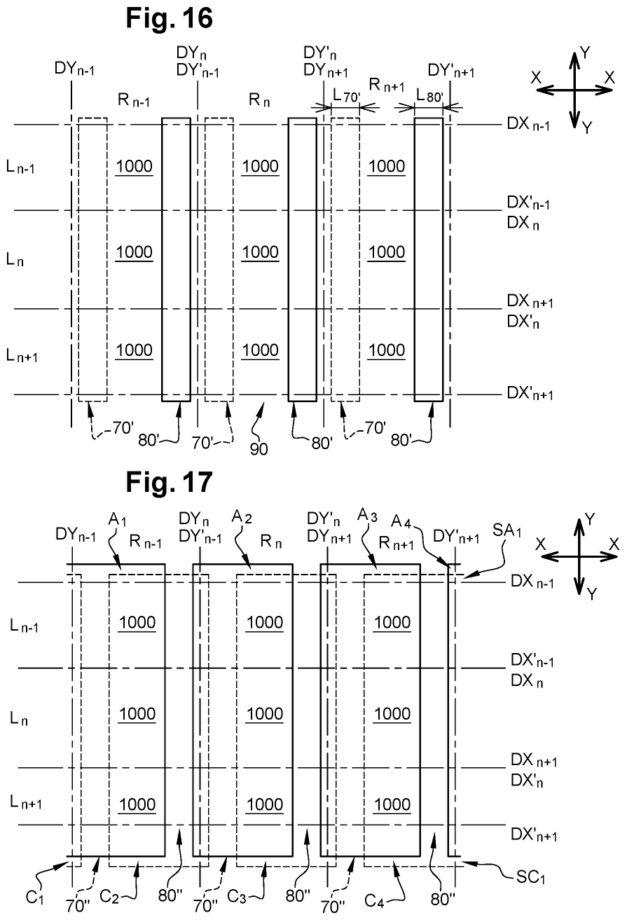

The batteries according to the invention can be made according to different variants. FIGS. 15 and 16 illustrate a variant of the first embodiment of the invention. The only difference, between the variant of these FIGS. 15 and 16 and the main variant above, lies in the fact that the anode and cathode foils no longer have slots 70, 80 (empty zones called small empty zones, free of any material of electrode, electrolyte and/or current collector substrate) but notches 70′, 80′. These notches form zones called large empty zones, free of any material of electrode, electrolyte and/or current collector substrate. In this variant, the anode notches 80′, respectively the cathode notches 70′, are distributed next to each other in rows R1 to. These anode notches 80′, respectively cathode notches 70′, preferably have the quadrilateral shape, typically of rectangular type. In the illustrated example, these notches also have an I-shape, like the slots of the first embodiment. However, as is apparent from the above, these notches 70′, 80′ are significantly more elongated than the slots, namely, they have a longitudinal dimension much greater than that of these slots. Consequently, the variation of FIGS. 15 and 16 differs from the main variation above, in that both each anode notch 80′ and each cathode notch 70′ is common to all lines L₁ to L_{y}, disposed one below the other.

In this manner, the slot 70, 80 positioned in line Lₙ is coincident with at least one of the adjacent slots positioned in line Lₙ₋₁ and/or Lₙ₊₁. In this case and as illustrated in FIG. 15, the two adjacent lines are not separated by material bridges. Two adjacent rows, however, are separated by material bridges 9 which give the anode and cathode foils a sufficient mechanical rigidity so that they can be easily handled. It is assumed that the stack of anode and cathode foils, described above, is subjected to steps aimed at ensuring its overall mechanical stability. These steps, of a type known per se, include in particular the heat treatment and/or the mechanical compression of the stack of the different foils, as has been previously described. As previously indicated, this stack allows the formation of individual batteries, the number of which is equal to the product between the number of lines Y and the number of rows X.

To this end, with reference to FIG. 16, three lines Lₙ₋₁ to Lₙ₊₁, as well as three rows Rₙ₋₁ to Rₙ₊₁, have been illustrated. In accordance with the invention, a first pair of cuts DXₙ and DX′ₙ are made per line. Each cut, which is performed right through, namely which extends over the entire height of the stack, is carried out in a manner known per se, as indicated above. The subsequent steps of impregnating, encapsulating, cutting along the cutting lines DYₙ and DY′ₙ, depositing the contact members on at least the anode and cathode connection zones are, advantageously, carried out as previously. The fact of using notches 70′, 80′ according to the first variant instead of slots 70, 80 allows reducing the material falls 90 and thus optimising the production of unit battery 1000. The battery 1000 obtained according to the first variant of the invention is in every aspect identical to that obtained according to the invention even though the arrangement of the notches 70′, 80′ is different.

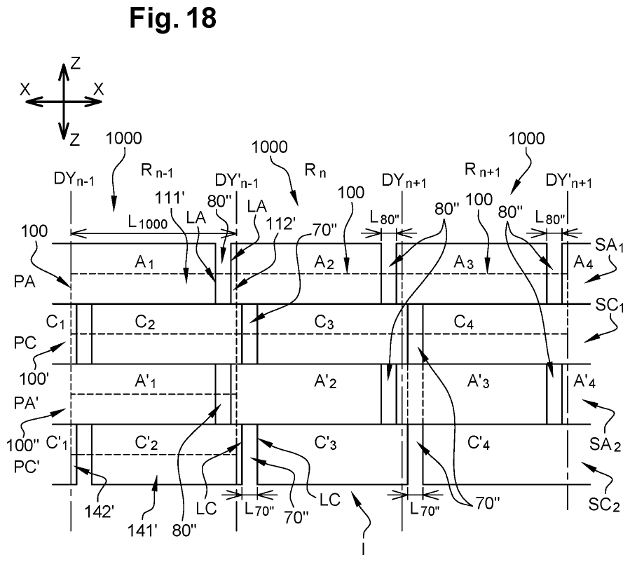

FIGS. 17 and 18 illustrate a second embodiment of the invention. The main difference between this second embodiment and the first embodiment described above, lies in the shape of the strata of the stack. As seen above, the first embodiment uses strata each formed by foils in one piece. However, in the second embodiment, each stratum is formed by a succession of strips, disposed next to each other according to respectively anode PA and cathode PC plane, which corresponds to the plane formed by a foil of the first embodiment.

In FIG. 18, only the first four strata are represented, namely the first two anode strata SA₁ and SA₂, as well as the first 2 cathode strata SC₁ and SC₂. Each anode stratum is formed by a succession of anode strips A₁ to Aₓ and A′₁ to A′ₓ, of which only the first 4 A₁ to A₄ and A′₁ to A′₄ are represented in FIGS. 17 and 18, while each cathode stratum is formed by a succession of cathode strips C₁ to Cₓ and C′₁ to C′ₓ, of which only the first 4 C₁ to C₄ and C′₁ to C′₄ are represented in the figures. For each stratum, both anode and cathode strata, the number of strips corresponds to the number of rows. Moreover, for each stratum, the opposite lateral edges LA and LC of the adjacent strips define free spaces 80″ and 70″ respectively. The respective anode strips A₁, A₂, A₃, A₄ and cathode strips C₁, C₂, C₃, C₄ preferably have a quadrilateral shape, typically of rectangular type. The respective anode strips A₁, A₂, A₃, A₄ and cathode strips C₁, C₂, C₃, C₄ have the same chemical structure as the respective anode foils and cathode foils used according to the invention or according to the first variant of the invention.

This second embodiment therefore differs, in other words, from the first embodiment essentially in that the different strips, respectively anode and cathode strips, are independent of each other. In this manner, each respective anode strip A₁, A₂, A₃, A₄ and cathode strip C₁, C₂, C₃, C₄ is not connected to a solid peripheral frame so as to form an anode, respectively cathode, foil as previously indicated.

According to the second embodiment of the invention, for a given row Rx, the anode strip A₁, A₂, A₃, A₄ is common to all lines L₁ to L_{y}, disposed one below the other, and the cathode strip C₁, C₂, C₃, C₄ is common to all lines L₁ to L_{y}, arranged one below the other.

According to the second embodiment of the invention and as illustrated in FIG. 18, the anode strips A₁, A₂, A₃, A₄, aligned along the anode plane PA parallel to the main plane of the battery, the cathode strips C₁, C₂, C₃, C₄ aligned along the cathode plane PC parallel to the main plane of the battery, the free spaces 80″ formed between two neighboring anode strips A₁, A₂ in a longitudinal direction and the free spaces 70″ formed between two neighboring cathode strips C₁, C₂ in a longitudinal direction are disposed so that: each anode strip Aₙ positioned in the row Rn is partially used as a secondary body of a battery 1000 positioned in the row Rₙ₋₁, and partially used as the primary body of a battery 1000 positioned in the row Rn, and each cathode strip Cₙ₊₁ is partially used as a secondary body of a battery 1000 positioned in the row Rₙ₊₁, and partially used as the primary body of a battery 1000 positioned in the row Rn.

It is assumed that the stack of anode and cathode strips, described above, is subjected to steps aimed at ensuring its overall mechanical stability. These steps, of a type known per se, include in particular the heat treatment and/or the mechanical compression of the stack of the different strips, as has been previously described. As previously indicated, this stack allows the formation of individual batteries, whose number is equal to the product between the number of lines Y and the number of rows X.

To this end, with reference to FIG. 17, three lines Lₙ₋₁ to Lₙ₊₁, as well as three rows Rₙ₋₁ to Rₙ₊₁ have been illustrated. In accordance with the invention, a first pair of cuts DXₙ and DX′n are made per line. Each cut, which is performed right through, namely which extends over the entire height of the stack, is carried out in a manner known per se, as previously indicated.

The subsequent steps of impregnating, encapsulating, cutting along the cutting lines DYₙ and DY′ₙ, as illustrated in FIG. 18, depositing the contact members on at least the anode and cathode connection zones are, advantageously, carried out as previously indicated. The fact of using anode strips A₁, A₂, A₃, A₄, and cathode strips C₁, C₂, C₃, C₄ according to the second variant allows reducing material falls 90 and thus optimising the production of unit batteries 1000. The battery 1000 obtained according to the second embodiment of the invention is in every aspect identical to that obtained according to the first embodiment from foils having small or large empty zones, even though the arrangement of the anode strips A₁, A₂, A₃, A₄, and cathode strips C₁, C₂, C₃, C₄ is different.

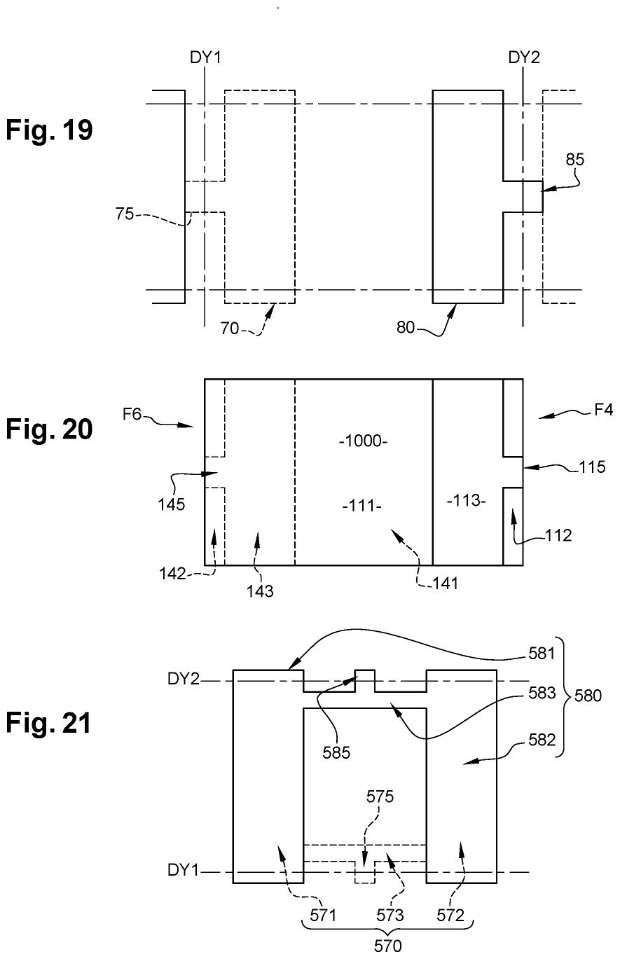

FIG. 19 illustrates a variant of the embodiment illustrated in FIG. 6. The stack of this FIG. 19 differs from that described in FIG. 6, in that each empty zone 70, 80 is extended by a respective channel 75, 85. Each channel extends transversely from the empty zone, beyond the opposite cutting line DY1 or DY2. In this manner, this channel can be passed through when making this cut. Different possibilities can be considered, with regard to the structure of these channels. Typically, the anode channels 85 are mutually superimposed, as are the cathode channels 75. Moreover, each anode channel is typically located in the extension of a cathode channel, given that an offset arrangement can be provided. Moreover, it can be provided to make, for the same empty zone, several anode channels and/or several cathode channels. In the direction Z, it can be provided that each channel extends over the entire height of the empty zone. Alternatively, this channel can extend over only part of this height, either in the upper portion, or in the lower portion, or even in the middle portion. The presence of these channels, both anode and cathode channels, provides specific advantages. Indeed, these channels allow, in particular, promoting the impregnation of the electrolyte.

FIG. 20 illustrates the final battery 1000, once made according to the method implemented thanks to the foils partially represented in FIG. 19. Each battery includes anode 115 and cathode 145 cavities, extending into a secondary body 112 and 142 from a respective free space 113 and 143. It will be noted that these cavities, which are formed from the above channels, however have a shorter length. Indeed, as has been mentioned, the channels extend beyond the cutting line. However, the cavities 115 and 145 extend only to the opposite longitudinal faces F4 and F6 of the battery, which are delimited by these cuts.

FIG. 21 shows an additional variant, which does not fall within the scope of the present invention. This variant is based in particular on the teaching of international patent application WO 2020 136313 on behalf of the applicant, in which the empty zones have an overall H shape According to the teaching of this document, each empty zone, such as that 570 or 580 of FIG. 21, includes two main recesses 571 or 581 as well as 572 or 582, which are mutually connected by a junction conduit 573 or 583.

According to the variant of FIG. 21, channels 575 and 585 are made, each of which extends a respective conduit 573 and 583, by being parallel to the main recesses. As in the embodiment of FIG. 19, each channel extends beyond a respective cutting line DY1 and DY2. The associated technical effect is to be compared to that of the embodiment of FIGS. 19 to 20, namely that the presence of the channel 575 or 585 ensures a better impregnation of the electrolyte.

The method according to the invention is particularly adapted for the manufacture of fully solid batteries, i.e. batteries whose electrodes and electrolyte are solid and do not comprise a liquid phase, even impregnated in the solid phase. The method according to the invention is particularly adapted for the manufacture of batteries considered to be quasi-solid comprising at least one separator 31 impregnated with an electrolyte. The separator is preferably a porous inorganic layer having: a porosity, preferably a mesoporous porosity, greater than 30%, preferably comprised between 35% and 50%, and even more preferably between 40% and 50%, and pores of average diameter D₅₀ less than 50 nm.

The thickness of the separator is advantageously less than 20 μm, and preferably comprised between 5 μm and 10 μm, so as to reduce the final thickness of the battery without reducing its properties. The pores of the separator are impregnated with an electrolyte, preferably with a lithium ion carrier phase such as liquid electrolytes or an ionic liquid containing lithium salts. The liquid which is “nano-confined” or “nano-trapped” in the porosities, and in particular in the mesoporosities, can no longer come out. It is linked by a phenomenon called herein “absorption in the mesoporous structure” (which does not seem to have been described in the literature in the context of lithium-ion batteries) and it can no longer come out even when the cell is put under vacuum. The battery is then considered as quasi-solid.

The battery according to the invention can be designed and dimensioned so as to have: a capacity less than or equal to about 1 mA h (commonly called “microbattery”), or a capacity greater than about 1 mA h.

Typically, the microbatteries are designed to be compatible with microelectronics manufacturing methods.

The batteries of each of these power ranges can be made: either with “all solid” type layers, i.e. devoid of impregnated liquid or pasty phases (the liquid or pasty phases can be a conductive medium of lithium ions, capable of acting as an electrolyte), either with mesoporous “all solid” type layers, impregnated with a liquid or pasty phase, typically a lithium ion conductive medium, which spontaneously enters inside the layer and which no longer comes out from this layer, such that this layer can be considered as quasi-solid, or with impregnated porous layers (i.e. layers having a network of open pores which can be impregnated with a liquid or pasty phase, and which gives these layers wet properties).

### REFERENCE SYMBOLS

The following references are used in these figures and in the following description:
1000 Battery according to the invention
1002 Anode connection zone
1006 Cathode connection zone
100 Unit cell
100′ Unit cell
100″ Unit cell
10 Anode current collector substrate
20 Anode layer
30 Layer of an electrolyte material/Electrolyte layer
31 Separator Layer
50 Cathode layer
40 Cathode current collector substrate
80 Anode slot
80′ Anode notch/Anode large empty zones
I₈₀ Total width/lateral dimension of anode slot
L₈₀ Total length/longitudinal dimension of anode slot
L_{80′} Total length/longitudinal dimension of anode notch
L_{80″} Total length/longitudinal dimension of anode free space
70 Cathode slot
70′ Cathode notch/Cathode large empty zones
I₇₀ Total width/lateral dimension of cathode slot
L₇₀ Total length/longitudinal dimension of cathode slot
L_{70′} Total length/longitudinal dimension of cathode notch
L_{70″} Total length/longitudinal dimension of cathode free space
110 Anode entity
111 Primary body of anode entity
141 Primary body of cathode entity
112 Secondary body of anode entity
142 Secondary body of cathode entity
113 Free space between primary body of anode entity and secondary body of anode entity
143 Free space between primary body of cathode entity and secondary body of cathode entity
140 Cathode entity
LA Lateral edges of the anode strips
LC Lateral edges of cathode strips
SA, SA₁, SA₂, . . . SAₙ Anode stratum
SC, SC₁, SC₂, . . . SCₙ Cathode stratum
111′ Primary preform of anode stratum
141′ Primary preform of cathode stratum
112′ Secondary preform of anode stratum
142′ Secondary preform of cathode stratum
80′ Empty zone between primary preform of anode stratum and secondary preform of anode stratum
70″ Empty zone between primary preform of cathode stratum and secondary preform of cathode stratum
80″ Free space formed between neighboring anode strips in longitudinal direction/anode free space
70″ Free space formed between two neighboring cathode strips in longitudinal direction/cathode free space
L₁₁₂ Length of secondary body of anode entity
L₁₁₃ Length of the free space between primary body of anode entity and secondary body of anode entity
L₁₄₂ Length of secondary body of cathode entity
L₁₄₃ Length of free space between primary body of cathode entity and secondary body of cathode entity
C₁ Cathode strip
C₂ Cathode strip
C₃ Cathode strip
C₄ Cathode strip
Cₙ Cathode strip
C′₁ Cathode strip
C′₂ Cathode strip
C′₃ Cathode strip
C′₄ Cathode strip
C′ₙ Cathode strip
A₁ Anode strip
A₂ Anode strip
A₃ Anode strip
A₄ Anode strip
Aₙ Anode strip
A′₁ Anode strip
A′₂ Anode strip
A′₃ Anode strip
A′₄ Anode strip
A′ₙ Anode strip
90 Material falls
95 Encapsulation system
97 Contact member
97′ Anode contact member
97′a Anode contact member lug covering the ends of the adjacent faces F1, F2, F3, F5 at the longitudinal face F6
97″ Cathode contact member
97″a Cathode contact member lug covering the ends of the adjacent faces F1, F2, F3, F5 at the longitudinal face F4
L₁₀₀₀ Length of battery
I Stack of anode foils having empty zones and cathode foils having empty zones/Stack of at least one unit cell
2e Anode foil having empty zones such as slots or notches
5e Cathode foil having empty zones such as slots or notches
4 Perforated central zone of the anode foil having elementary entities
6 Peripheral frame of the anode foil having elementary entities
7 Perforations present at the four ends of the anode foils and cathode foils
8 Material bridges between two lines
I₈ Width of the bridges
9 Second material bridges between two rows of slots
L₉ Length of second material bridges
XX Longitudinal/horizontal direction of stack/battery
YY Lateral/transverse direction of stack/battery
ZZ Frontal direction of stack/battery
L Slot line/Battery line
Lₙ Slot line/Battery line
Lₙ₋₁ Slot line/Battery line
Lₙ₊₁ Slot line/Battery line
R Slot row
Rₙ Slot row
Rₙ₋₁ Slot row
Rₙ₊₁ Slot row
PA, PA′ Anode plane
PC, PC′ Cathode plane
DXₙ₋₁ First pair of accessory cuts
DX′ₙ₋₁ First pair of accessory cuts
DXₙ First pair of accessory cuts
DX′ₙ First pair of accessory cuts
DXₙ₊₁ First pair of accessory cuts
DX′ₙ₊₁ First pair of accessory cuts
DYₙ₋₁ Second pair of main cuts
DY′ₙ₋₁ Second pair of main cuts
DYₙ Second pair of main cuts
DY′ₙ Second pair of main cuts
DYₙ₊₁ Second pair of main cuts
DY′ₙ₊ Second pair of main cuts
AA Interface between encapsulation system and contact members
2000 Prior art battery
200, 200′, 200″ Unit cell of prior art battery
2002 Anode connection zone of prior art battery
2006 Cathode connection zone of prior art battery
295 Encapsulation system of prior art battery
F1, F2 Front faces of stack/battery
F3, F5 Lateral faces of stack/battery
F4, F6 Longitudinal faces of stack/battery
FF1, FF2 Front faces of battery line (Lₙ)
FF3, FF5 Lateral faces of battery line (Lₙ)
FF4, FF6 Longitudinal faces of battery line (Lₙ)

1-18. (canceled)

19. A method for manufacturing a plurality of one batteries, the method comprising:
a) forming a stack that includes in a top view, x rows and y lines to form a number (x*y) of batteries, with x being greater than 1 and y being greater than or equal to 1, the stack being formed by an alternating succession of strata respectively cathode strata and anode strata, each cathode stratum forming a number (x*y) of cathode entities and each anode stratum forming a number (x*y) of anode entities,
each anode stratum having a plurality of primary anode preforms which form a primary anode body and a plurality of secondary anode preforms which form a secondary anode body, the primary anode preforms and the secondary anode preforms being mutually separated by an empty zone which forms at least one free space,
each cathode stratum having a plurality of cathode primary preforms which form a cathode primary body and a plurality of secondary cathode preforms which form a secondary cathode body, the primary cathode preforms and the secondary cathode preforms being mutually separated by an empty zone which form at least one free space, and
when each battery includes a plurality of free spaces in a frontal direction of each battery: the empty zones of different anode strata are superimposed, the empty zones of different cathode strata are superimposed, and the empty zones of each anode stratum and each cathode stratum are not coincident,
b) conducting a heat treatment and/or a mechanical compression of the formed stack to form a consolidated stack;
c) making a pair of main cuts between two adjacent empty zones, in a top view, so as to expose the anode connection zone and the cathode connection zone, and to separate a given battery, formed from a given row (Rₙ), from at least one other adjacent battery, formed from at least one adjacent row (Rₙ₊₁,
wherein each battery in the formed batteries includes the anode entities and the cathode entities, disposed one above each other in an alternating manner in the frontal direction of each battery, each anode entity including an anode current collector substrate, at least one anode layer, and a layer of an electrolyte material or a separator impregnated with an electrolyte, each cathode entity including a cathode current collector substrate, at least one cathode layer, and another layer of an electrolyte material or a separator impregnated with an electrolyte, each battery having a pair of front faces which are mutually parallel to each other, parallel to each anode entity and, to each cathode entity, a pair of lateral faces which are mutually parallel to each other, and a pair of longitudinal faces that includes a first longitudinal face and a second longitudinal face which are mutually parallel to each other, the first longitudinal face having the anode connection zone and the second longitudinal face having the cathode connection zone that is laterally opposite to the anode connection zone, and
wherein each anode entity includes the primary anode body separated from the secondary anode body by the free space of any electrode, electrolyte and current collector substrate material, and each cathode entity includes the primary cathode body separated from the secondary cathode body by the free space of any electrode, electrolyte and current collector substrate material.

20. The method of claim 19, wherein each anode stratum and each cathode stratum is formed by a foil in one piece, the empty zones corresponding to material falls in the foil.

21. The method of claim 19, wherein each anode stratum and each cathode stratum is formed by a plurality of independent strips, the empty zones being defined between edges facing the adjacent strips.

22. The method of claim 19, wherein the empty zones include called small empty zones formed as slots which form a single free space.

23. The method of claim 22, wherein the empty zones include large empty zones formed as notches which form a plurality of free spaces in a same row (Re).

24. The method of claim 19, wherein the empty zones have an I-shape.

25. The method of claim 19, further comprising, after making the pair of main cuts:
making a pair of accessory cuts that facilitate a separation of a given line of batteries from at least one adjacent line of the consolidated stack.

26. The method of claim 25, wherein further comprising, after making the pair of accessory cuts:
impregnating the consolidated stack or the impregnation of the line of batteries with liquid electrolytes or an ionic liquid containing lithium salts, such that the separator layer is impregnated with an electrolyte.

27. The method of claim 26, further comprising, after impregnating the consolidated stack or the impregnation of the line of batteries:
encapsulating the consolidated stack or the line of batteries with a multi-layered encapsulation structure that covers an outer periphery of the consolidated stack or the line of batteries.

28. The method of claim 27, wherein the multi-layered encapsulation structure comprises:
at least one first cover layer selected from parylene, parylene-type F, polyimide, epoxy resins, silicone, polyamide, sol-gel silica, organic silica, and/or a mixture thereof,
a second cover layer composed of an electrically insulating material, and
at least one third cover layer serving as a waterproof layer having a water vapor permeance (WVTR) of less than 10⁻⁵ g/m²·d, the at least one third cover layer being composed of a ceramic material and/or a low melting point glass, having a melting point less than 600° C.

29. The method of claim 28, further comprising, after encapsulating the consolidated stack or the line of batteries:
covering at least the first longitudinal face that includes the anode connection zone with an anode contact member operable to ensure electrical contact between the consolidated stack and an outer conductive element, and covering at least the second longitudinal face that includes the cathode connection zone with a cathode contact member operable to ensure electrical contact between the consolidated stack and another outer conductive element,
depositing on at least the first longitudinal face that includes the anode connection zone and on at least the second longitudinal face that includes the cathode connection zone, a first electrical connection layer of material loaded with electrically conductive particles, said first electrical connection layer being formed of polymeric resin and/or a material obtained by a sol-gel method loaded with electrically conductive particles,
drying and then polymerizing the polymeric resin and/or the material obtained by the sol-gel method, and
depositing, on the first electrical connection layer, a second electrical connection layer comprising a metal foil,
depositing, on the second electrical connection layer, a third electrical connection layer comprising a conductive ink.

30. The method of claim 25, wherein:
the pair of main cuts are performed by laser ablation, and
the pair of accessory cuts are performed by laser ablation.

31. The method of claim 19, further comprising forming at least one transverse channel from the empty zones, the at least transverse channel extending at least to an adjacent main cut to facilitate impregnation of the consolidated stack or the line of batteries with liquid electrolytes or an ionic liquid containing lithium salts.

32. A battery, comprising:
a stack formed by at least one anode entity and at least one cathode entity, disposed one above each other in an alternating manner in a frontal direction of the battery, each anode entity including an anode current collector substrate, at least one anode layer, and a layer of an electrolyte material or a separator impregnated with an electrolyte, each cathode entity including a cathode current collector substrate, at least one cathode layer, and another layer of an electrolyte material or a separator impregnated with an electrolyte;
wherein:
the stack has a pair of front faces which are mutually parallel to each other, parallel to: each anode entity, each cathode entity, the anode current collector substrate, the at least one anode layer, the layer of electrolyte material or the layer of separator impregnated with the electrolyte, the at least one cathode layer, and the cathode current collector substrate,
the stack has a pair of lateral faces which are mutually parallel to each other,
the stack has a pair of longitudinal faces that includes a first longitudinal face and a second longitudinal face which are mutually parallel to each other, the first longitudinal face having the anode connection zone and the second longitudinal face having the cathode connection zone that is laterally opposite to the anode connection zone,
each anode entity includes a primary anode body separated from the secondary anode body by a free space of any electrode, electrolyte, and current collector substrate material,
each cathode entity includes a primary cathode body separated from the secondary cathode body by a free space of any electrode, electrolyte, and current collector substrate material,
the stack includes a plurality of free spaces in the frontal direction of a main plane of the battery, the free spaces formed between each primary anode body and each secondary anode body of each anode entity being superimposed, the free spaces formed between each primary cathode body and each secondary cathode body of each anode entity being superimposed, and the free spaces of each anode entity and each cathode entity not being coincident, and
a multi-layered encapsulation structure that covers at least in part an outer periphery of the stack to cover the front faces the lateral faces, and the longitudinal faces in a manner so as to not cover the first longitudinal face and the second longitudinal face, multi-layered encapsulation structure including:
at least one first cover layer selected from parylene, parylene-type F, polyimide, epoxy resins, silicone, polyamide, sol-gel silica, organic silica, and/or a mixture thereof,
a second cover layer composed of an electrically insulating material, and
at least one third cover layer which serving as a waterproof layer having a water vapor permeance (WVTR) of less than 10⁻⁵ g/m²·d, the at least one third cover layer being composed of a ceramic material and/or a low melting point glass, having a melting point less than 600° C.

33. The battery of claim 32, further comprising:
a first outer conductive element and a second outer conductive element;
an anode contact member covering at least the first longitudinal face, and which is operable to ensure electrical contact between the consolidated stack and the first outer conductive element;
a cathode contact member covering at least the second longitudinal face, and which is operable to ensure electrical contact between the consolidated stack and the second outer conductive element.

34. The battery of claim 33, further comprising:
a first electrical connection layer on at least the first longitudinal face and the second longitudinal face, the first electrical connection layer being composed of a polymeric resin having electrically conductive particles and/or a material obtained by a sol-gel method having electrically conductive particles, and
a second electrical connection layer comprising a metal foil disposed on the first electrical connection layer.

35. The battery of claim 32, wherein the battery has a capacity less than or equal to 1 mA h.

36. The battery of claim 32, wherein the battery has a capacity greater than 1 mA h.

37. The battery of claim 32, further comprising a cavity, extending through the secondary cathode body to an opposite one of the first longitudinal face and the second longitudinal face, to extend the free spaces.
